(19) United States
(12) Patent Application Publication
(10) Pub. No.: US 2024/0233566 A9
(43) Pub. Date: Jul. 11, 2024

(54) PREFERENCE-BASED ORGANIZATION OF DEMO TOURS WITH LAYERED MEDIA

(71) Applicant: Consensus Sales, Inc., American Fork, UT (US)

(72) Inventors: Brian Zurcher, St. George, UT (US); David Lindes, Salt Lake City, UT (US); Garin Hess, Saratoga Springs, UT (US); Cory Crouch, Taylorsville, UT (US); William Racule, Lehi, UT (US); Jeannie Laochaloenvanich, Pflugervile, TX (US)

(21) Appl. No.: 18/490,612

(22) Filed: Oct. 19, 2023

Related U.S. Application Data
(60) Provisional application No. 63/380,200, filed on Oct. 19, 2022.

(51) Int. Cl. G09B 5/06

(52) U.S. Cl. CPC G09B 5/065

(57) ABSTRACT

A system may receive inputs selecting an interest level from among a plurality of interest levels for each of a set of topics. the system may determine displayable information describing a subset of the set of topics based on the inputs, which displayable information may include media segments. The system may generate a sequence for the displayable information for the subset of topics using the inputs and defined ordering criteria, and it may present, for display in a graphical user interface on a client device, a digital demonstration including the sequence of the displayable information for the subset of topics.

### BACKGROUND

This application relates to the creation and of online demonstrations. For example, technologies described in this application may allow administrative users to create digital demonstrations (“demos”), which may be customized within certain constraints by end users.

Currently, demonstration presentations are created and are statically presented to users. Accordingly, users may be forced to sit through uninteresting features of a demo in order to receive information in which they are interested.

Furthermore, previous technologies for creating or viewing demos lack organization, do not allow customization or targeting for users, and do not allow varying levels of adjustability. These previous technologies lacked features that allow use of demos on computing devices with limited processing or bandwidth capabilities or with limited display sizes. Accordingly, previous technologies required that entire demos be transmitted, viewed, or otherwise processed, which resulted in significant waste of time and resources.

### SUMMARY

A system for preference-based organization of demo tours can be configured to perform particular operations or actions by virtue of having software, firmware, hardware, or a combination of them installed on the system that in operation causes or cause the system to perform the actions. In some aspects, the techniques described herein relate to a computer-implemented method of generating a digital demonstration for a subject matter including: receiving one or more first inputs selecting an interest level from among a plurality of interest levels for each of a set of topics; determining displayable information describing a subset of the set of topics based on the one or more first inputs, the displayable information including one or more media segments; generating a sequence for the displayable information for the subset of topics using the one or more first inputs and defined ordering criteria; and presenting, for display in a graphical user interface on a client device, a digital demonstration including the sequence of the displayable information for the subset of topics.

In some aspects, the techniques described herein relate to a computer-implemented method, wherein presenting the digital demonstration includes: presenting a digital tour for a topic of the subset of topics, the digital tour providing information relating to the topic in the digital demonstration, the digital tour including a sequence of steps that describe subtopics of the topic.

In some aspects, the techniques described herein relate to a computer-implemented method, wherein presenting the digital tour for the topic includes: overlaying at a defined location on an image for the topic, an interactable graphical element; receiving by the client device, a second user input selecting the interactable graphical element; in response to receiving the second user input, displaying a video segment in a media player in an overlay at a location associated with the selected interactable graphical element; and updating the selected interactable graphical element to indicate that user has interacted with the selected interactable graphical element via the graphical user interface.

In some aspects, the techniques described herein relate to a computer-implemented method, wherein: the digital tour includes an interactable graphical element for each step in the sequence of the steps, the interactable graphical elements for the sequence of steps being displayable subject to the sequence of steps; and the digital tour includes one or more independent graphical elements displayable in the digital tour independently from the sequence of steps.

In some aspects, the techniques described herein relate to a computer-implemented method, further including: receiving data including a plurality of images for the digital demonstration; determining a sequence of the plurality of images; and associating the plurality of images with a topic of the set of topics.

In some aspects, the techniques described herein relate to a computer-implemented method, further including: receiving multiple media items for the digital demonstration; associating each of the multiple media items with one or more of the set of topics; and associating each of the set of topics with one or more of the plurality of interest levels.

In some aspects, the techniques described herein relate to a computer-implemented method, further including: determining the defined ordering criteria including determining a sequence of the set of topics based on one or more second inputs, the sequence for the displayable information for the subset of topics being based on the sequence of the set of topics and the one or more first inputs selecting the interest level for each of the set of topics.

In some aspects, the techniques described herein relate to a computer-implemented method, wherein: the defined ordering criteria includes a first sequence of the set of topics and a second sequence of information elements within each topic of the set of topics.

In some aspects, the techniques described herein relate to a computer-implemented method, wherein: a digital tour is associated with a topic of the subset of topics, the digital tour including the second sequence of the information elements in a story path defining logic for displaying the information elements in the digital tour for the topic.

In some aspects, the techniques described herein relate to a computer-implemented method, further including: displaying in the graphical user interface on the client device, a set of topic cards for subset of topics based on the one or more first inputs and the defined ordering criteria.

In some aspects, the techniques described herein relate to a computer-implemented method, wherein: each topic card of the set of topic cards includes a summary of information elements associated with the topic card, each topic card being associated with a topic of the subset of topics.

In some aspects, the techniques described herein relate to a computer-implemented method, wherein: a topic card of the set of topic cards includes a graphical element representing a video associated with the topic, the graphical element representing the video being selectable to open a popup window in the graphical user interface, the popup window displaying the video.

In some aspects, the techniques described herein relate to a computer-implemented method, further including: a topic card of the set of topic cards includes a graphical element representing a digital tour associated with the topic, the graphical element representing the digital tour being selectable to display the digital tour in a content region of the graphical user interface, the digital tour including a set of images with a plurality of hotspot graphical elements overlayed on one or more of the set of images in the content region.

In some aspects, the techniques described herein relate to a system including: one or more processors; and a computer-readable memory storing instructions that, when executed by the one or more processors, cause the system to perform operations including: receiving one or more first inputs selecting an interest level from among a plurality of interest levels for each of a set of topics; determining displayable information describing a subset of the set of topics based on the one or more first inputs, the displayable information including one or more media segments; generating a sequence for the displayable information for the subset of topics using the one or more first inputs and defined ordering criteria; and presenting for display in a graphical user interface on a client device, a digital demonstration including the sequence of the displayable information for the subset of topics.

In some aspects, the techniques described herein relate to a computer-implemented method including: receiving, by one or more processors, one or more first inputs selecting an interest level from among a plurality of interest levels for each of a set of topics; determining displayable information describing a subset of the set of topics based on the one or more first inputs, the displayable information including one or more media segments; generating a sequence for the displayable information for the subset of topics using the one or more first inputs and defined ordering criteria; and presenting for display in a graphical user interface on a client device, a digital demonstration including the sequence of the displayable information for the subset of topics including: presenting a digital tour for each topic of the subset of topics, the digital tour providing information relating to the topic in the digital demonstration, the digital tour including a sequence of steps that describe subtopics of the topic, the digital tour including a plurality of images and a plurality of tour elements overlayed at defined locations on the plurality of images, the defined ordering criteria including a first sequence of the set of topics and a second sequence of the steps within the topic.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for providing intelligent organization of demos.

FIG. 2 is a block diagram of an example computing system.

FIG. 3A illustrates an example method for creating a customizable demo.

FIG. 3B illustrates an example method for customizing a customizable demo.

FIG. 3C illustrates an example method for presenting a customized demo to a user in a graphical user interface on a client device.

FIGS. 4A-4F illustrate example graphical user interfaces in which a demo may be initiated and customized, according to some implementations.

FIGS. 4G-4K illustrate example graphical user interfaces in which graphical topic cards are displayed in a customized organization and an example tour is correspondingly displayed.

FIG. 4L illustrates an example graphical user interface for displaying additional information regarding other topics in a demo.

FIG. 4M illustrates an example graphical user interface for forwarding a customizable demo to another user by an end user.

FIG. 4N illustrates an example graphical user interface in which analytics for a demo may be displayed.

FIGS. 5A-5C illustrate example graphical user interfaces in which one or more tour elements are shown in multiple steps of a tour.

FIGS. 6A-6E illustrate example graphical user interfaces in which multiple steps of a tour are displayed in a story path for a customized demo.

FIG. 7 illustrates an example graphical user interface in which a customizable demo for a user or organization may be generated.

### DESCRIPTION

The present disclosure relates to systems and methods for preference-based organization of digital demonstrations, such as computer-based presentations or demonstrations of the features of a software service (also referred to herein as a demo or demo tour). The demos may include layered information, such as textual, audio, or video media. In some instances, the layered information may also include graphical elements overlayed on an image in a demo that allow user-interaction, such as an HTML button overlayed and/or associated with a defined location on a background image.

A demonstration presentation or demo may include explanations and/or demonstrations of one or more topics, which may each include corresponding information or topic data. For example, the topic data may include a tour of the topic, such as of a service, webpage, software application, or portion thereof. The tour may be organized into pages that include an image with one or more overlayed or associated tour elements. A tour element may be a component or data of the tour that may be displayed and/or interacted with to provide information about an aspect or subtopic of the tour. In some implementations, the tour elements for a tour may be organized into sets and/or sequences to provide a narrative flow or story path within the tour. Further implementations and explanations are included below.

Implementations of the technology provide a system for building a customizable demo with components that are defined by a creating user or administrator and/or definable by an end user. For example, an administrator may define various features of a customizable demo, and an end consumer selects a preference level for each feature, which dynamically builds a demo based on both the end user's selections and criteria, such as a narrative flow, from the administrator/back-end builder. The length of clips, demos, and other features may be organized as cards with potentially multiple media types and/or layers depending on the selection. For instance, as described below, a demo may include information with increasing depths and various paths of media through which a user may proceed.

Implementations of the technology provide a system for creating a customizable demo that can easily be customized by an end-user. Cards having associated demonstration data can be created and ordered for each attribute or topic in a demo. In some implementations, a card may be graphically displayed in association with the display of the demo. Each card can have various media types and lengths that may correspond to an end user's preference level. For example, a card may include a various media, such as a video, a tour, etc. The tour may include a sequence of tour elements, such as text, video, interactable graphical buttons, or other elements described herein. In some instances, a tour element may be associated with an action that is performed by a user to complete the tour element and cause the technology to progress to a subsequent tour element. For example, the tour may have hot spots (e.g., graphical buttons overlayed on a page or image) selection of which may cause the technology to display additional information in instructional popups that may include additional videos, steps, or links to other information. The customizable demo may be organized to provide visual story telling in a way that is customizable by an end user but retains a narrative flow originally created by the administrator.

Accordingly, digital demonstrations may be dynamically and automatically customized to an end user while enabling consistency across users. The technology provides advanced, varying personalization, which provides customizable, multi-layered demonstration data that may include image links, button links, text, media and other data. The demo(s), cards describing topics of the demo, and other information may be organized into various dashboards and other interfaces, as described below.

In some implementations, an administrative user may select a language, which may automatically update text and/or other elements throughout a demo for the selected language. The demo application 108 may automatically translate the text and/or may select language, elements, data, etc., based on an associated language to automatedly build and customize demos to the language.

Throughout access and interaction with a demo application 108, it may track the access/interaction, analyze the data, and provide it at various points and interfaces. The analytics data may indicate interests of user(s), effectiveness of topic data describing a topic, interaction times, tour elements with which a user has interacted, overall progress through one or more story paths, or other data. For example, the analytics data may include heat maps that indicate what a user watched, how long they watched it, and if they rewatched a video or other data. Analytics may be associated with demos, topics, topic data, end-users, administrative users, salespeople, organizations, or otherwise.

For example, the demo application 108 may display visual analytics in the form of bar graphs, line graphs, tables of data, or otherwise. For instance, view time, importance of various topics, completion of portions of sequences or steps of tours, etc., as described elsewhere herein.

In some implementations, the demo application 108 may display a summary of demo views for a user invited or about to be invited. For example, the demo application 108 may access a file in a database associated with an identified user, which may indicate which demos the user has viewed. The summary may indicate information (e.g., total views, views over time, etc.) for each user during the invitation process. Accordingly, based on the provided information, the administrator or other sharer of the demo may modify the demo shared or the users to whom it is shared before providing access.

In some implementations, for purposes of retrieving demo data, determining analysis, and providing analysis data, the demo application 108 may integrate and communicate with third-party servers, services, and applications. For instance, the demo application 108 may communicate (e.g., via APIs, etc.) with Salesforce™, Outlook™, Gmail™, customer relationship managers, etc.

As described and evident throughout this description, among numerous other benefits, the technologies described herein significantly improve memory, storage, bandwidth, and processor utilization over prior methods of generating and/or presenting presentations. Not only do the technologies improve the way that information is displayed, but they may also reduce the processing, transmission, and/or storage of extraneous data, for example, that is not needed in a specific context, such as for a specific user or otherwise.

With reference to the figures, reference numbers may be used to refer to example components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

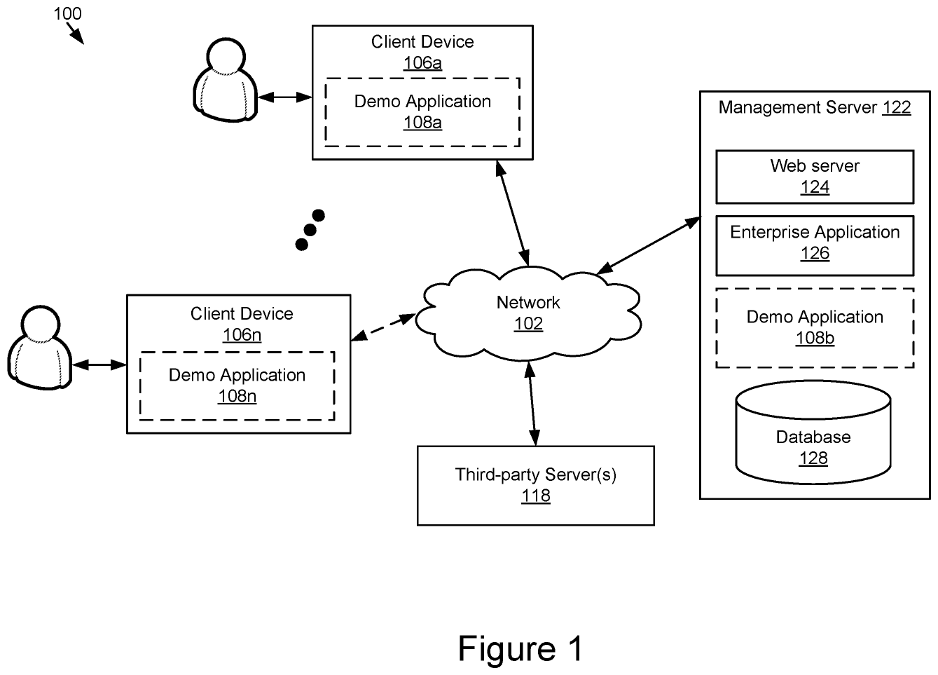

FIG. 1 is a block diagram of an example system 100 for providing preference-based organization of demos, which may be organized based on both the preferences of an end user and defined criteria of an administrator. The demos may also include layered information previewed in customizable cards and multi-layered information in tour elements, such as hot spots in a graphical interface. The illustrated system 100 may include one or more client devices 106, a third-party server 118, and/or a management server 122, which may run instances of the demo application 108a . . . 108n and which may be electronically communicatively coupled via a network 102 for interaction with one another, although other system configurations are possible including other devices, systems, and networks. For example, the system 100 could include any number of client devices 106, third-party servers 118, management server(s) 122, and other systems and devices.

The network 102 may include any number of networks and/or network types. For example, the network 102 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The client device(s) 106 (e.g., multiple client devices 106 may be used by a single user, multiple users, stakeholders, or by other users) includes one or more computing devices having data processing and communication capabilities. The client device 106 may couple to and communicate with other client devices 106 and the other entities of the system 100 via the network 102 using a wireless and/or wired connection, such as the management server 122. Examples of client devices 106 may include, but are not limited to, mobile phones, wearables, tablets, laptops, desktops, netbooks, server appliances, servers, virtual machines, televisions, etc. The system 100 may include any number of client devices 106, including client devices 106 of the same or different type.

In some implementations, one or multiple client devices 106 may be used with a demo application 108 to execute an instance or component thereof or to otherwise access the demo application 108, for example, via the web server 124.

The management server 122 and its components may aggregate information about and provide data associated with the systems and processes described herein to a multiplicity of users on a multiplicity of client devices 106, for example, as described in reference to various users and client devices 106 described herein. In some implementations, a single user may use more than one client device 106a . . . 106n, which the management server 122 as described above, or multiple users may use multiple client devices 106a . . . 106n to interact with to perform operations described herein. In some implementations, the management server 122 may communicate with and provide information to a client device 106.

The management server 122 may include a web server 124, an enterprise application 126, a demo application 108, and/or a database 128. In some configurations, the enterprise application 126 and/or demo application 108 may be distributed over the network 102 on disparate devices in disparate locations or may reside in the same location. The client device 106a and/or the management server 122 may each include an instance of the demo application 108 and/or portions/functionalities thereof. The client devices 106 may also store and/or operate other software such as a demo application 108, an operating system, other applications, etc., that are configured to interact with the management server 122 via the network 102.

The management server 122 and/or the third-party server 118 have data processing, storing, and communication capabilities, as discussed elsewhere herein. For example, the servers 118 and/or 122 may include one or more hardware servers, server arrays, storage devices and/or systems, etc. In some implementations, the servers 118 and/or 122 may include one or more virtual servers, which operate in a host server environment.

In some implementations, the enterprise application 126 may receive communications from a client device 106 in order to perform the functionality described herein. The enterprise application 126 may receive information and provide information to the demo application 108 to generate adaptable graphical interfaces described, as well as perform and provide analytics and other operations. In some implementations, the enterprise application 126 may perform additional operations and communications based on the information received from client devices 106, as described elsewhere herein.

The database 128 may be stored on one or more information sources for storing and providing access to data, such as the data storage device 208. The database 128 may store data describing client devices 106, instances of the demo application 108, media segments, composite data files, metadata, preferences, configurations, and other information, such as described herein.

A third-party server 118 can host services such as a third-party application (not shown), which may be separate and/or incorporated into the services provided by the management server 122. For example, the third-party server 118 may represent one or more item databases, forums, company websites, etc. For instance, a third-party server 118 may provide automatically delivered and processed data, such as frames, attributes, media segments, and/or services, such as media processing services or other services.

It should be understood that the system 100 illustrated in FIG. 1 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

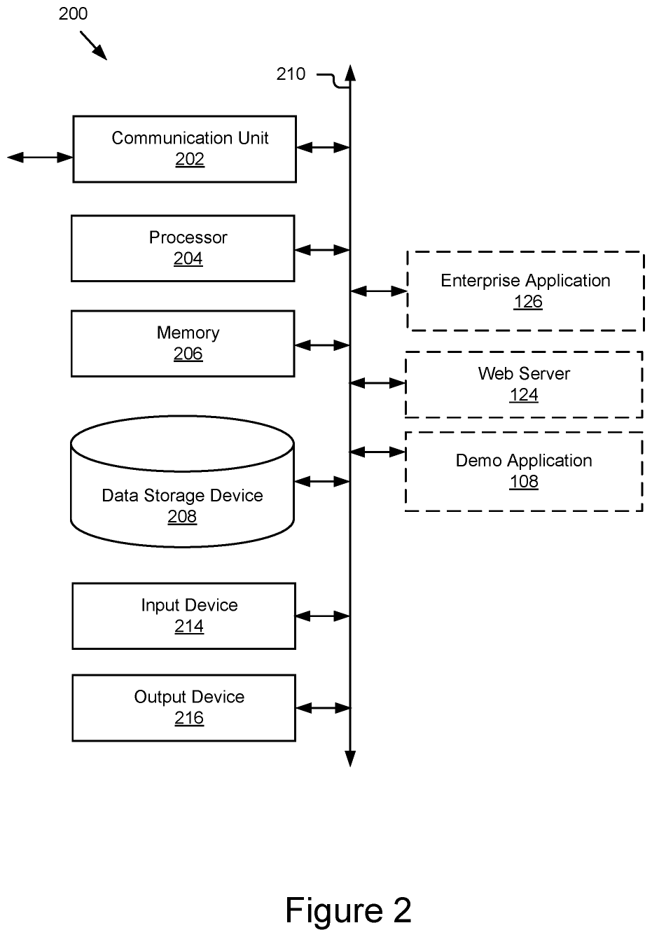

FIG. 2 is a block diagram of an example computing system 200, which may represent computer architecture of a client device 106, third-party server 118, management server 122, and/or another device described herein, depending on the implementation. In some implementations, as depicted in FIG. 2, the computing system 200 may include an enterprise application 126, a web server 124, a demo application 108, or another application, depending on the configuration. For instance, a client device 106 may include or execute a demo application 108 (which could incorporate various aspects of the enterprise application 126, in some implementations); and the management server 122 may include the web server 124, the enterprise application 126, and/or components thereof, although other configurations are also possible and contemplated.

The enterprise application 126 includes computer logic executable by the processor 204 to perform operations discussed elsewhere herein. The enterprise application 126 may be coupled to the data storage device 208 to store, retrieve, and/or manipulate data stored therein and may be coupled to the web server 124, the demo application 108, and/or other components of the system 100 to exchange information therewith.

The web server 124 includes computer logic executable by the processor 204 to process content requests (e.g., to or from a client device 106). The web server 124 may include an HTTP server, a REST (representational state transfer) service, or other suitable server type. The web server 124 may receive content requests (e.g., product search requests, HTTP requests) from client devices 106, cooperate with the enterprise application 126 to determine the content, retrieve and incorporate data from the data storage device 208, format the content, and provide the content to the client devices 106.

In some instances, the web server 124 may format the content using a web language and provide the content to a corresponding demo application 108 for processing and/or rendering to the user for display. The web server 124 may be coupled to the data storage device 208 to store retrieve, and/or manipulate data stored therein and may be coupled to the enterprise application 126 to facilitate its operations.

The demo application 108 includes computer logic executable by the processor 204 on a client device 106 to provide for user interaction, receive user input, present information to the user via a display, and send data to and receive data from the other entities of the system 100 via the network 102. In some implementations, the demo application 108 may generate and present user interfaces based on information received from the enterprise application 126, third-party server 118, and/or the web server 124 via the network 102. For example, a customer/user may use the demo application 108 to perform the operations described herein.

As depicted, the computing system 200 may include a processor 204, a memory 206, a communication unit 202, an output device 216, an input device 214, and a data storage device 208, which may be communicatively coupled by a communication bus 210. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 200 may include various operating systems, sensors, additional processors, and other physical configurations. The processor 204, memory 206, communication unit 202, etc., are representative of one or more of these components.

The processor 204 may execute software instructions by performing various input, logical, and/or mathematical operations. The processor 204 may have various computing architectures to method data signals (e.g., CISC, RISC, etc.). The processor 204 may be physical and/or virtual and may include a single core or plurality of processing units and/or cores. In some implementations, the processor 204 may be coupled to the memory 206 via the bus 210 to access data and instructions therefrom and store data therein. The bus 210 may couple the processor 204 to the other components of the computing system 200 including, for example, the memory 206, the communication unit 202, the input device 214, the output device 216, and the data storage device 208.

The memory 206 may store and provide access to data to the other components of the computing system 200. The memory 206 may be included in a single computing device or a plurality of computing devices. In some implementations, the memory 206 may store instructions and/or data that may be executed by the processor 204. For example, the memory 206 may store one or more of the enterprise application 126, the web server 124, the demo application 108, and their respective components, depending on the configuration. The memory 206 is also capable of storing other instructions and data, including, for example, an operating system, hardware drivers, other software applications, databases, etc. The memory 206 may be coupled to the bus 210 for communication with the processor 204 and the other components of computing system 200.

The memory 206 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 204. In some implementations, the memory 206 may include one or more of volatile memory and non-volatile memory (e.g., RAM, ROM, hard disk, optical disk, etc.). It should be understood that the memory 206 may be a single device or may include multiple types of devices and configurations.

The bus 210 can include a communication bus for transferring data between components of a computing device or between computing devices, a network bus system including the network 102 or portions thereof, a processor mesh, a combination thereof, etc. In some implementations, the enterprise application 126, web server 124, demo application 108, and various other components operating on the computing system/device 100 (operating systems, device drivers, etc.) may cooperate and communicate via a communication mechanism included in or implemented in association with the bus 210. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 202 may include one or more interface devices (UF) for wired and wireless connectivity among the components of the system 100. For instance, the communication unit 202 may include, but is not limited to, various types of known connectivity and interface options. The communication unit 202 may be coupled to the other components of the computing system 200 via the bus 210. The communication unit 202 can provide other connections to the network 102 and to other entities of the system 100 using various standard communication protocols.

The input device 214 may include any device for inputting information into the computing system 200. In some implementations, the input device 214 may include one or more peripheral devices. For example, the input device 214 may include a keyboard, a pointing device, microphone, an image/video capture device (e.g., camera), a touchscreen display integrated with the output device 216, etc. The output device 216 may be any device capable of outputting information from the computing system 200. The output device 216 may include one or more of a display (LCD, OLED, etc.), a printer, a haptic device, audio reproduction device, touch-screen display, a remote computing device, etc. In some implementations, the output device is a display which may display electronic images and data output by a processor of the computing system 200 for presentation to a user, such as the processor 204 or another dedicated processor.

The data storage device 208 may include one or more information sources for storing and providing access to data. In some implementations, the data storage device 208 may store data associated with a database management system (DBMS) operable on the computing system 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The data stored by the data storage device 208 may be organized and queried using various criteria including any type of data stored by them, such as described herein. For example, the data storage device 208 may store the database 128. The data storage device 208 may include data tables, databases, or other organized collections of data. Examples of the types of data stored by the data storage device 208 may include, but are not limited to, the data described with respect to the figures, for example, the data may include user accounts, media segments, topic data, topic cards, administrative roles, user roles, etc.

The data storage device 208 may be included in the computing system 200 or in another computing system and/or storage system distinct from but coupled to or accessible by the computing system 200. The data storage device 208 can include one or more non-transitory computer-readable mediums for storing the data. In some implementations, the data storage device 208 may be incorporated with the memory 206 or may be distinct therefrom.

The components of the computing system 200 may be communicatively coupled by the bus 210 and/or the processor 204 to one another and/or the other components of the computing system 200. In some implementations, the components may include computer logic (e.g., software logic, hardware logic, etc.) executable by the processor 204 to provide their acts and/or functionality. In any of the foregoing implementations, the components may be adapted for cooperation and communication with the processor 204 and the other components of the computing system 200.

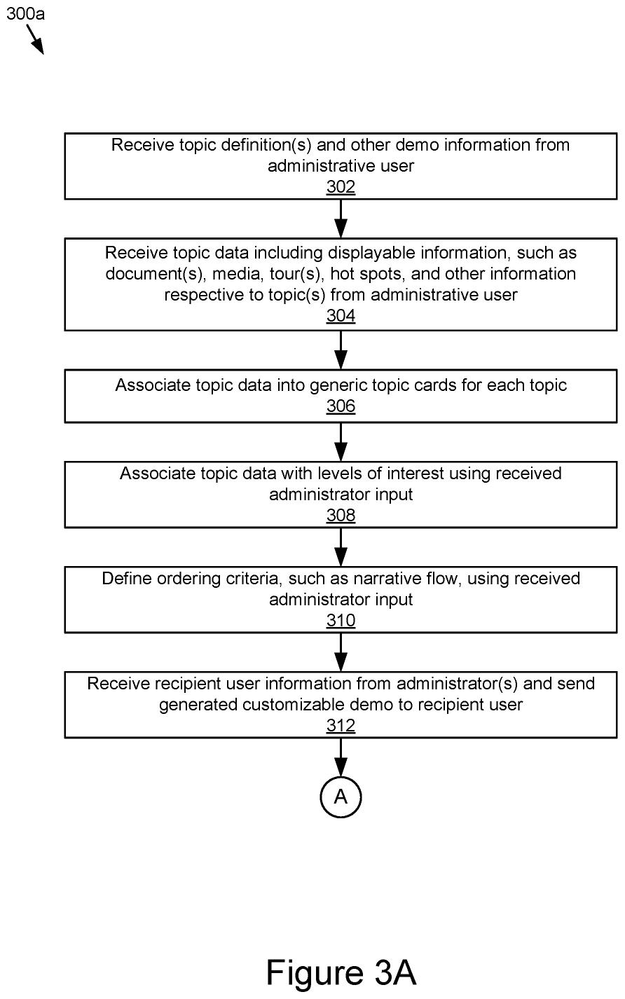

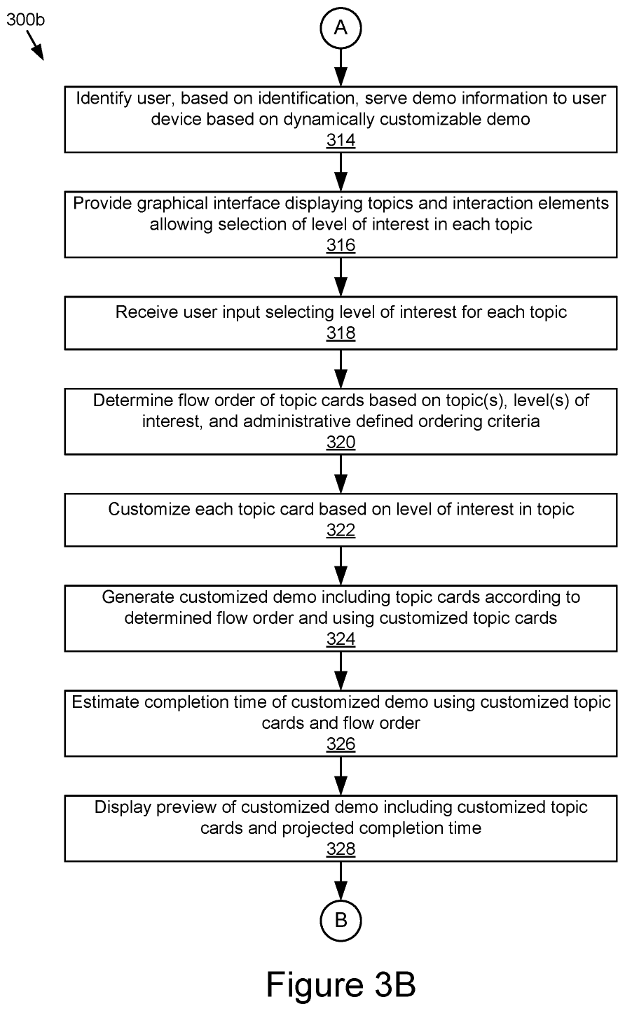

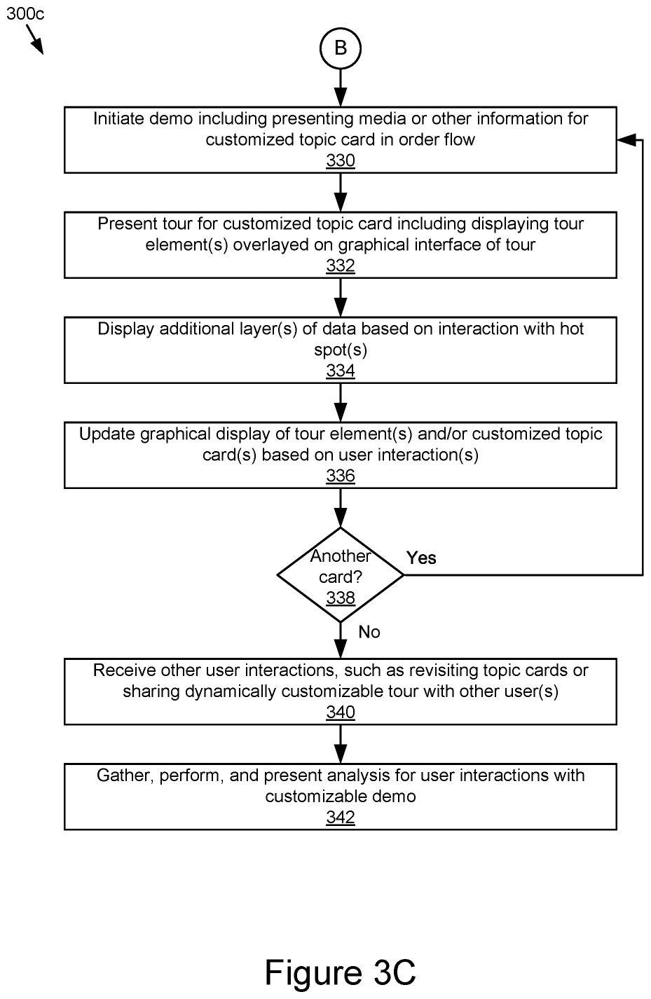

FIGS. 3A-3C illustrate flowcharts of example methods 300a, 300b, and 300c, which provide operations for creating and using a customizable digital demonstration, as described elsewhere herein. FIG. 3A illustrates an example method 300a for creating (e.g., by an administrative user) a customizable demo, such as by defining demo information, topics, topic cards, topic data, an order flow, defining tour element (e.g., hot spot) locations and behaviors, and performing other operations. FIG. 3B illustrates an example method 300b for customizing, by an end user, a customizable digital demonstration, for example, subject to constraints of the customizable demo and using variable flow and information (e.g., defined story flow(s), tours, topic cards, etc.). FIG. 3C illustrates an example method 300c for presenting a customized demo including customizations, topic cards, topic data, tour elements, hot spots, tours, multi-layered textual and/or media data, and so forth, as described herein.

In some implementations, at 302, the demo application 108 may receive topic definitions and/or demonstration information, for example, from an administrative user and/or a database. The demo application 108 may use the information to generate a demo pertaining to a subject matter, such as a piece of software, a website, or another set of one or more topics. The administrative user may provide a title, contact information, metadata, description, introductory media for a demo and/or for each topic in a customizable demo. For instance, the administrator may define introductory information, such as an introductory video for various user roles, such as for end users. It should be noted that although the demo is described in reference to topics, it may have other organizations, such as nested relationships of topics, subtopics, sub subtopics, etc., which may describe features, lessons, or other attributes of a subject. As noted below, a video may be uploaded or recorded for a specific user.

In some implementations, at 304, the demo application 108 may receive topic data including displayable information, such as documents, images, tour pages, media, tours, tour elements, hot spots, and/or other information respective to topics, for example, from an administrative user and/or a database. A media element or media item may include, for example, an image, video, tour element, audio clip, HTML page, or other media. For instance, the administrator may define topics for a digital, customizable demonstration, which may describe attributes of products. The administrator may provide textual and/or graphical descriptions of each topic, which may be organized into pages, videos, audio, tours, or various other formats. For example, the administrator may upload, download, enter, and/or organize topic data, which may include supplementary documents, external information, explanations, or other data for each topic.

In some implementations, the administrator may upload a video describing or illustrating a topic. The administrator may also create or upload a tour, which walks through features of the topic step by step. Supplementary documents may also be provided in association with each topic or subtopic.

In some implementations, for each tour or element thereof, the administrator may define locations (e.g., graphical locations on a graphical interface of a tour) of tour elements, hot spots, or graphical buttons, which may be hovered over or selected to provide additional information relative to a tour attribute. In some implementations, the administrator may define information displayed when the tour element is hovered over, information displayed when the tour element is selected, or otherwise. For example, textual data, another tour, media (e.g., an audio and/or video segment), or other data may be displayed when a hot spot is hovered over and/over selected. For example, a popup or overlay may be displayed, or a separate page may be displayed.

Example operations for defining a demo, tour, tour elements, media, or other aspects are described in further detail elsewhere herein.

At 306, the demo application 108 may associate the topic data (e.g., documents, media, a tour, etc.) into one or more topic cards for each topic. For instance, a topic card may include a graphical representation of topic data associated with a topic. In some implementations, a topic card may be customizable/automatically customized by the demo application 108 based on interactions by an end user and/or defined criteria, such as those defined at 308 and 310. As noted below, one or more topic cards may be defined for the same topic and associated with interest levels, contexts, story paths, or other attributes. For example, which topic cards are displayed in a customized demo to an end user may be based on selected interest levels, story paths, or other criteria.

At 308, the demo application 108 may associate topic data with levels of interest, for example, based on administrator input or automatically based on a relative quantity of the topic data or topic cards for a topic. For instance, an administrator may provide input defining an association of data (or topic cards, tour element, media segment, etc.) for each topic, subtopic, etc., with a level of interest, for example, selected from “very important,” “somewhat important,” or “not important,” although other implementations are possible. The administrator may associate an element of a topic card or of topic data with one or more levels of interest. The administrator may upload and/or associate separate videos, tours, documents, tour elements, or other information with varying levels of interest. In some instances, a tour element, media segment, etc., may be associated with multiple levels of interest (e.g., where fewer elements/less data is associated with lower levels of interest).

For example, if an end user selects “very interested” or (“very important”) in a topic, the demo application 108 may provide a topic card with a longer video and a tour for the topic. If the user selects “somewhat interested”, the demo application 108 may provide a shorter video and no tour (or just a video, just a tour, just text, etc.) to the user thereby reducing extraneous elements. Accordingly, bandwidth, time, and processing resources are reduced for the demo presented to the user thereby increasing efficiency, especially for low bandwidth devices and/or across many users, for example, by reducing data transmitted, processed, and/or displayed, depending on the implementation.

At 310, the demo application 108 may define ordering or sequencing criteria, such as a narrative flow, using received administrator input. For example, the administrator may provide an order (e.g., a sequence) of topics or subtopics, an order of elements within a topic card (e.g., text, media, a tour, tour elements, etc.), logic defining order, or other data. The order may be based on a narrative, so that topics are described providing a sequenced narrative to the end user either overall and/or within a grouping, topic card, or tour according to interest levels. For instance, the administrator may define an order of topics, topic cards, topic data within a demo. In other instances, the administrator may define an order of topics, etc., which may be presented within groupings, cards, or tours based on interest level.

In some implementations, in addition or in alternative from the sequence of tour elements in a tour or topic card, the demo application 108 may determine a sequence/order for topics. For example, “very important” topics may be presented first, “somewhat important” topics may be presented second, and “not important” topics may be presented third or not at all, while the order within these groupings is based on the administrator defined criteria/narrative order.

In some implementations, individual tours may be defined, which may be used, in combination with other tours or media, for instance, to create a demo. For instance, a tour may be a set and/or series of steps explaining features of a product, subject, a topic, subtopic, etc. A demo may include zero, one, or multiple tours for each topic, and an overall digital demonstration presentation (also referred to herein as a demo) may include one or more topics, as noted elsewhere herein.

For example, as described in further detail below, a sequence and/or set of tour elements may be added to a tour, for example, where each element is associated with a page or image in a tour. For example, a tour element may include text, a popup window, audio or video, buttons, HTML elements, or other elements that may describe, for instance, aspects or subtopics of a topic. As the administrator adds the tour elements, the demo application 108 may automatically add the tour elements to a sequence/story path for the tour in the order in which they were added. An administrative user may manually change the order or mark a tour element as independent from the story path, so that it may be displayed separately from a sequence. In some implementations, the administrator may define a logic for progression between steps or tour elements in a tour, for example, so that multiple paths or varying sequences may be performed during a tour. In some instances, selection, viewing, or other interaction may be defined for each tour element to allow each step or tour element in a story path to be displayed (e.g., where a next step is unlocked based on completion of one or more previous actions).

It should be noted that the operations of the methods may be performed in other orders, for example, the operations 304-310 may be performed simultaneously or in a different chronological sequence than described.

In some implementations, the administrator may create a summary or concluding topic or demonstration component that is automatically displayed to the user after display of all topic cards and/or after completion of some or all of the actions in the demo. In some implementations, the demo application 108 may automatically generate a summary of the topics (potentially based on interest level) reviewed by the user. For example, the demo application 108 may automatically combine the titles and/or descriptions for each topic, tour element, or other element of the demo into a summary, which is automatically displayed to the user upon completion of the demo.

Once the administrator is satisfied with the creation of the customizable demo, they may provide other data. Some implementations of the demo application 108 may receive recipient/end user information from the administrator and send the generated customizable (e.g., either the demo files or access thereto) to the user. For instance, the administrator may provide access via e-mail or otherwise.

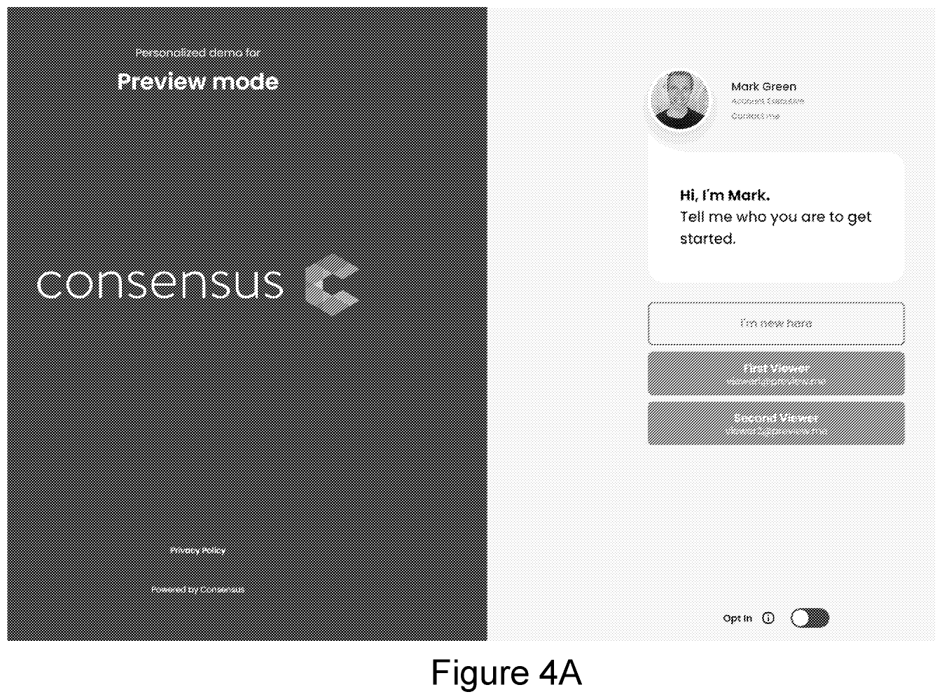

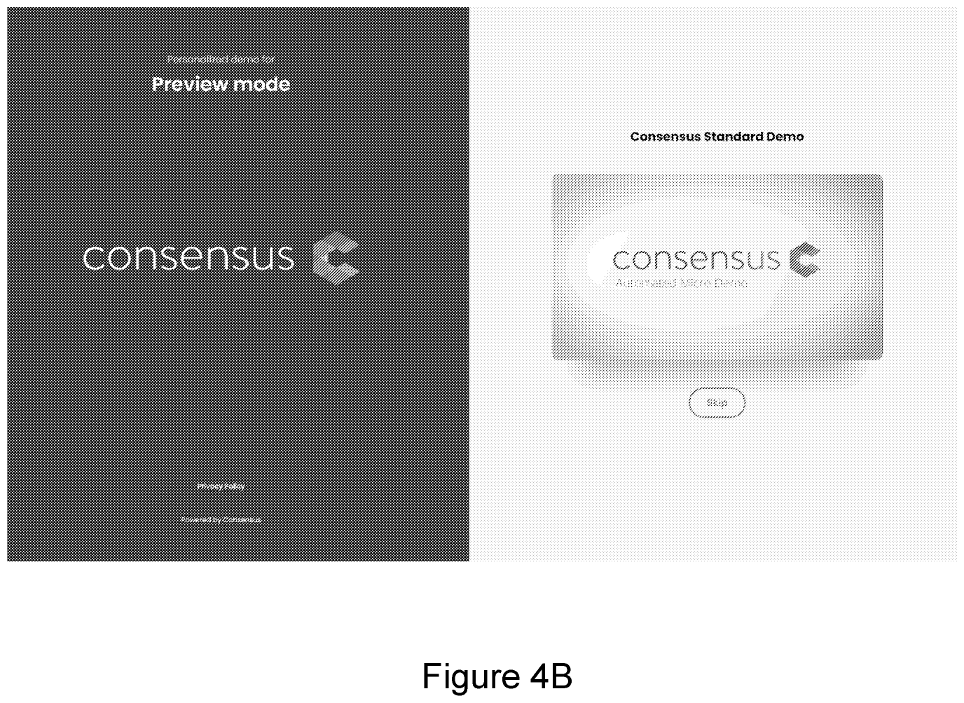

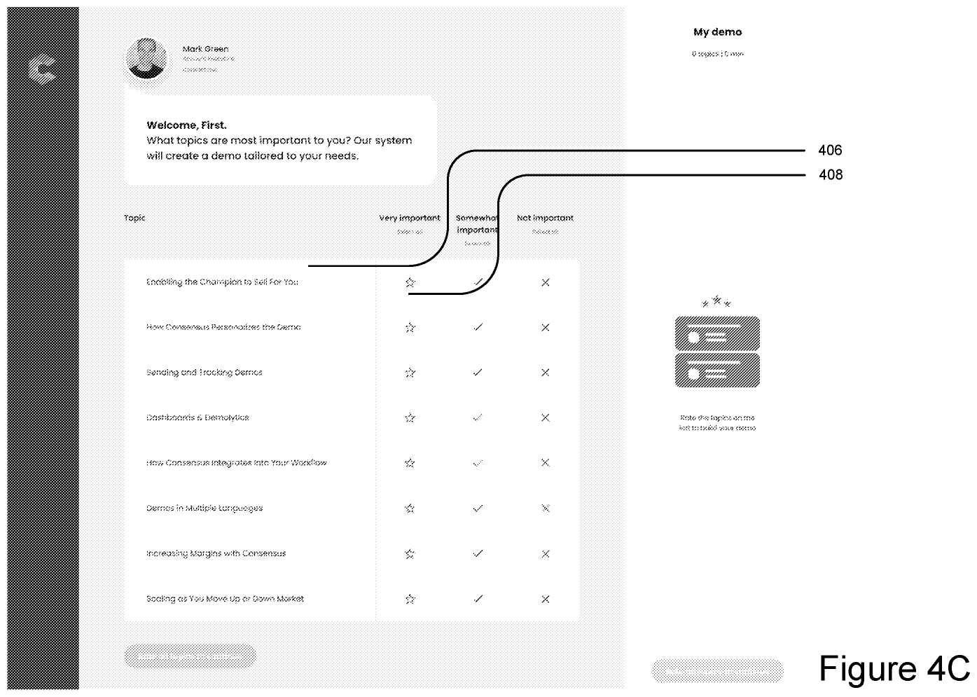

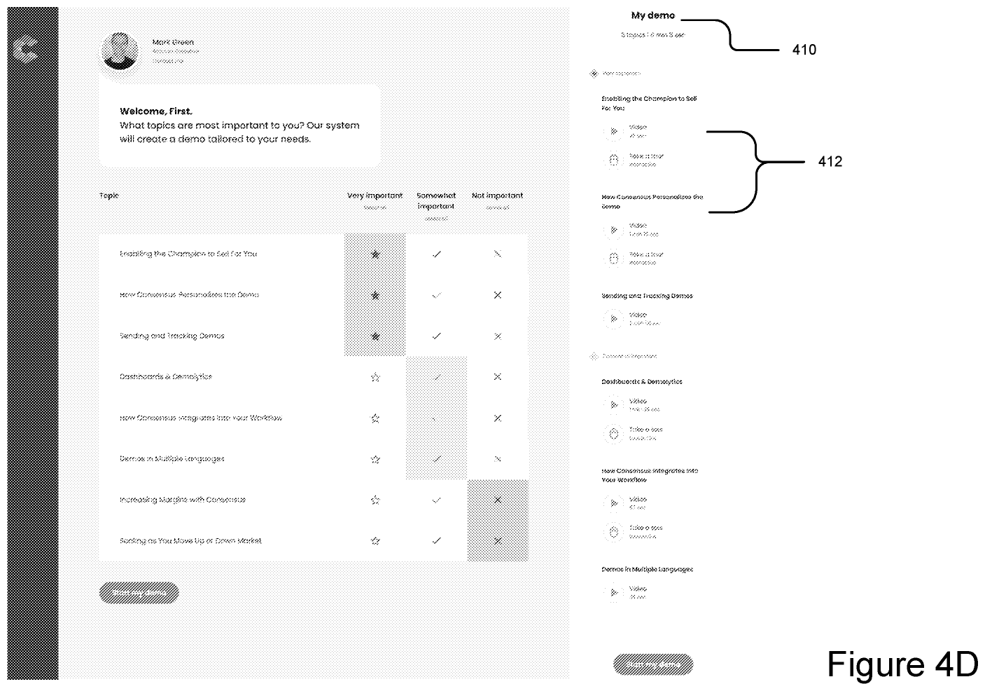

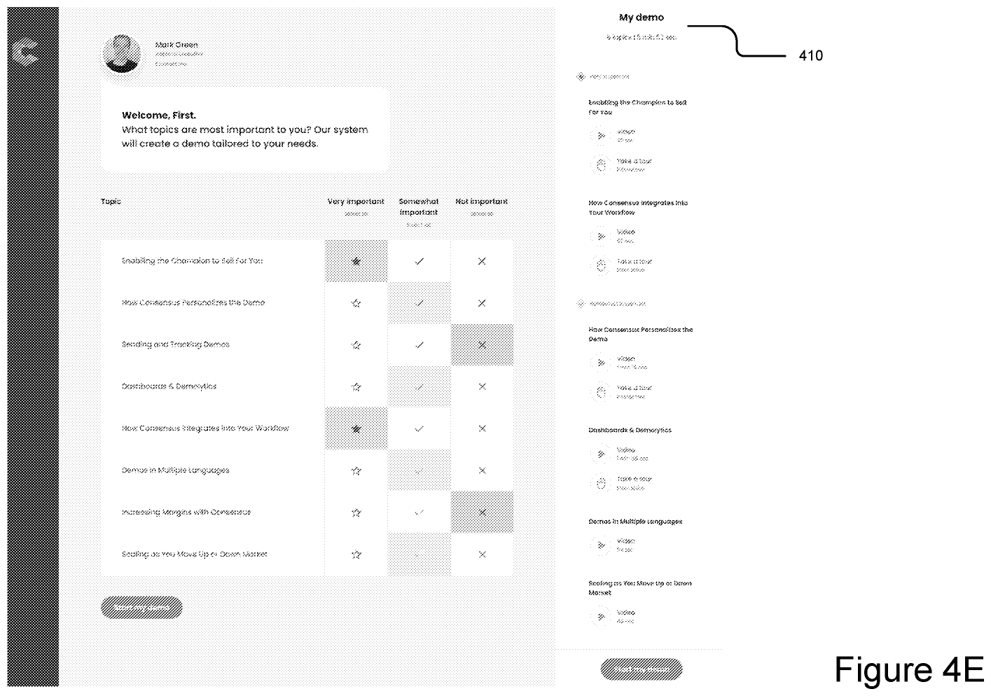

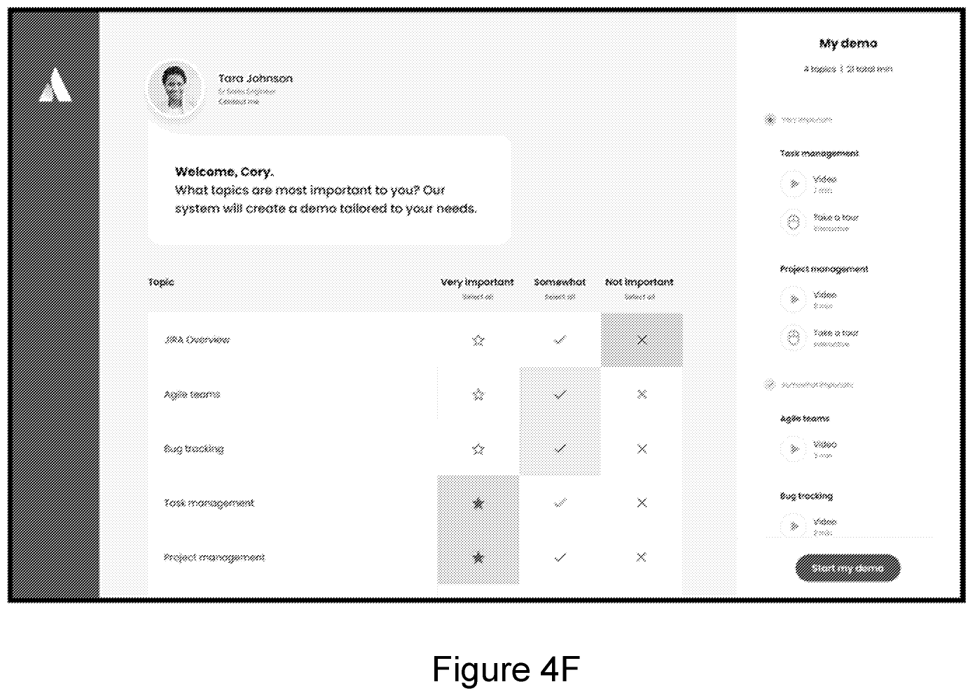

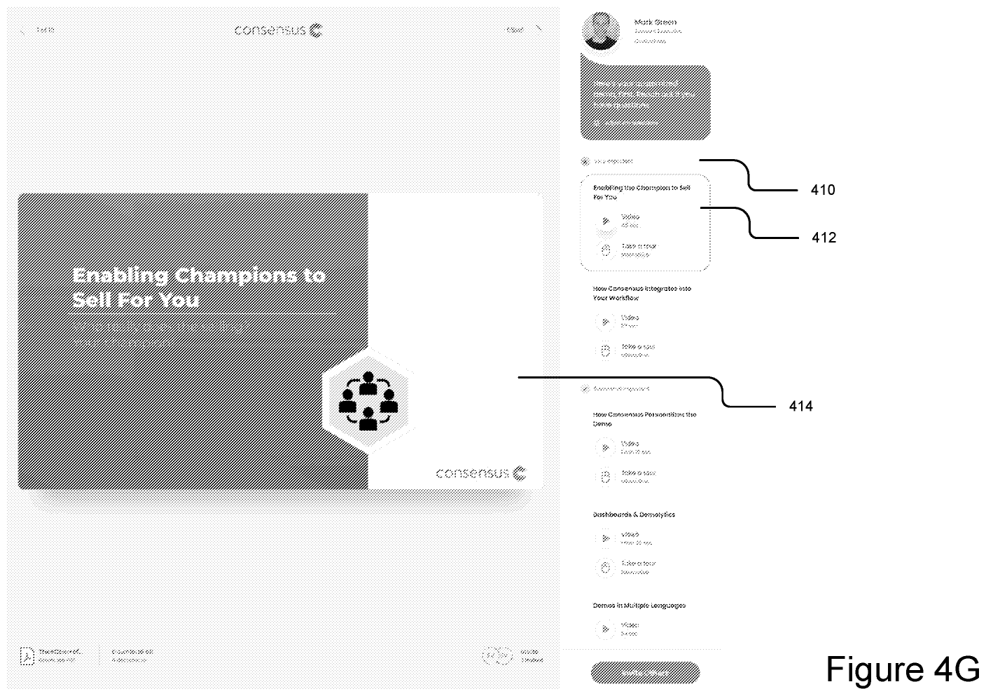

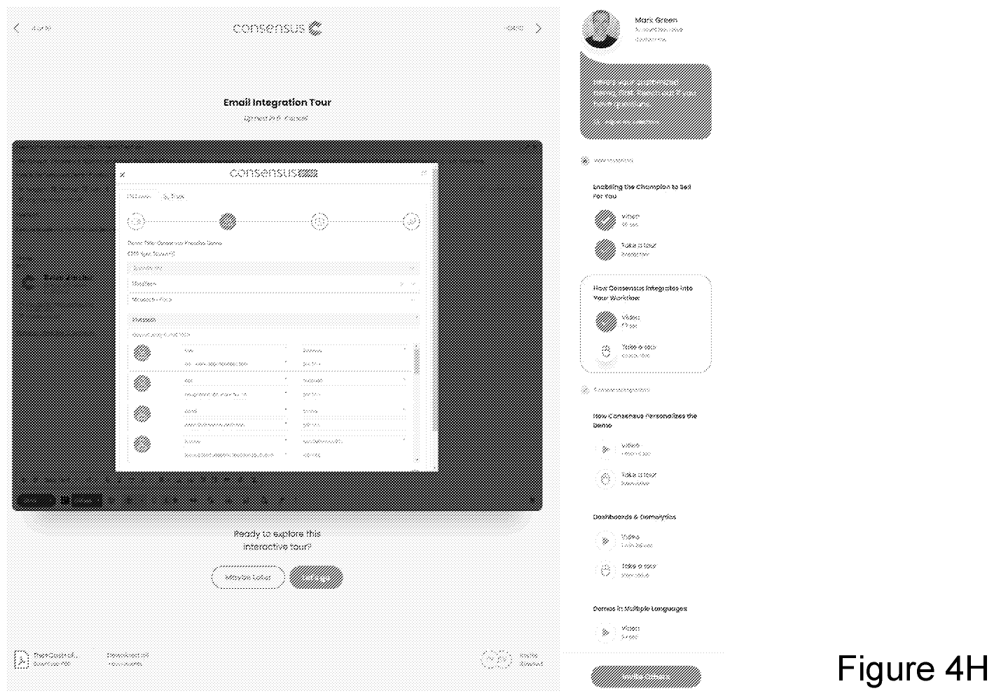

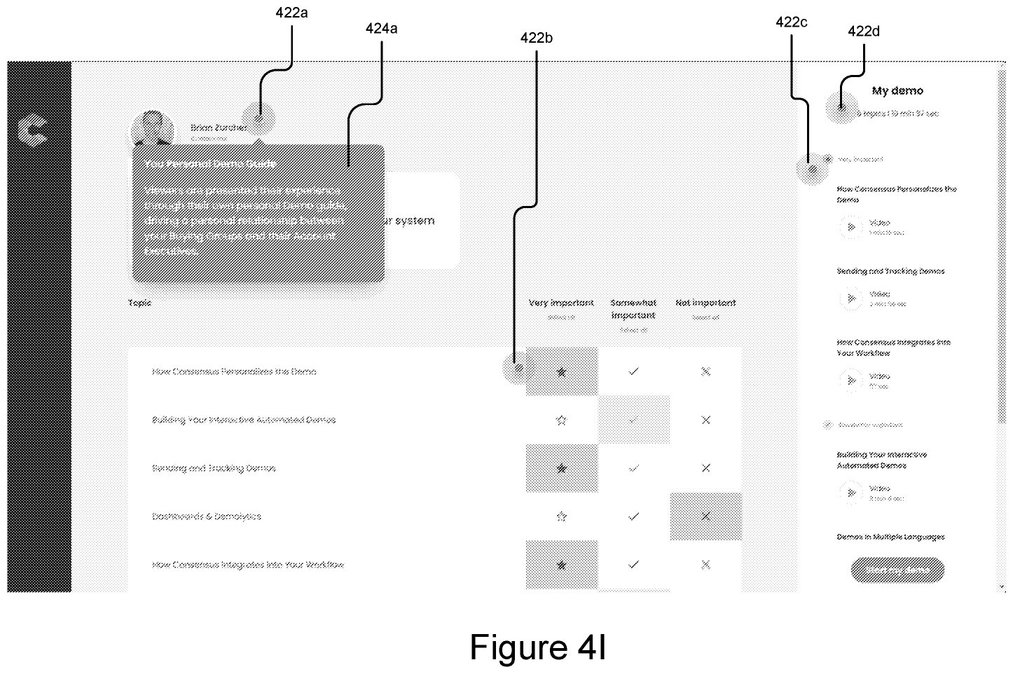

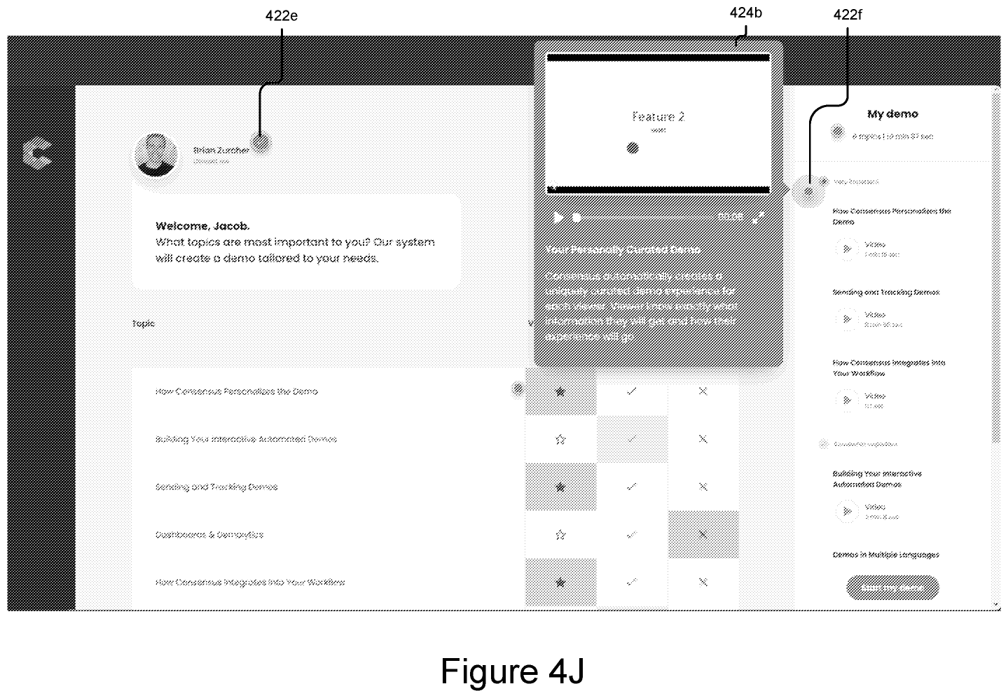

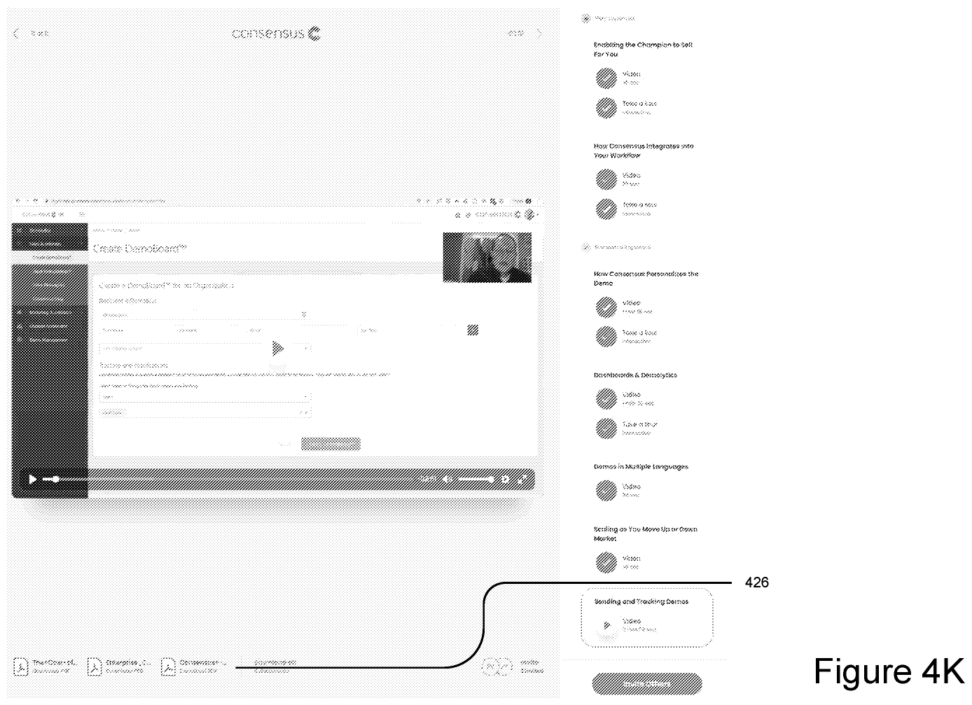

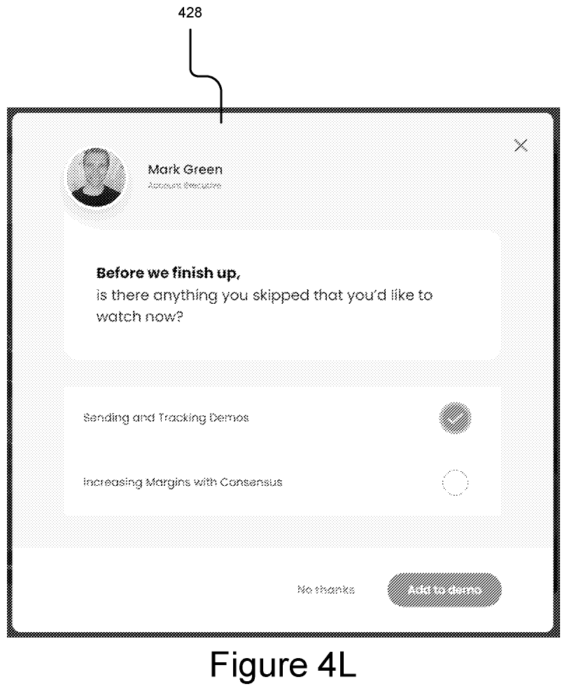

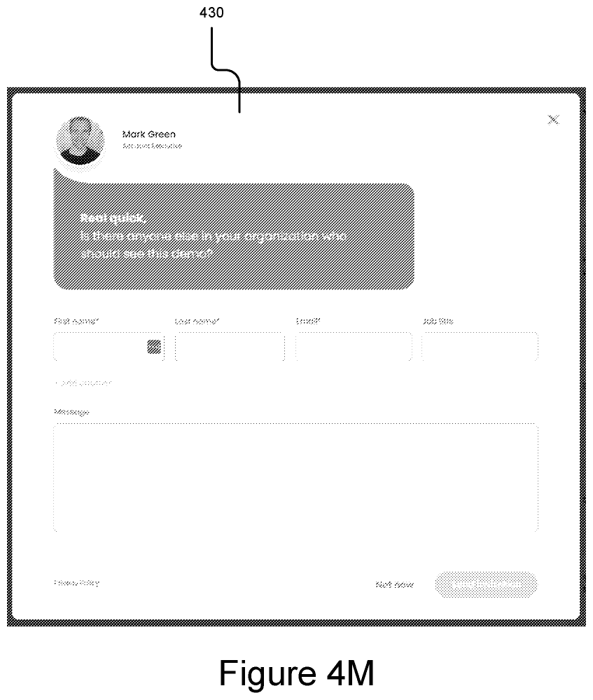

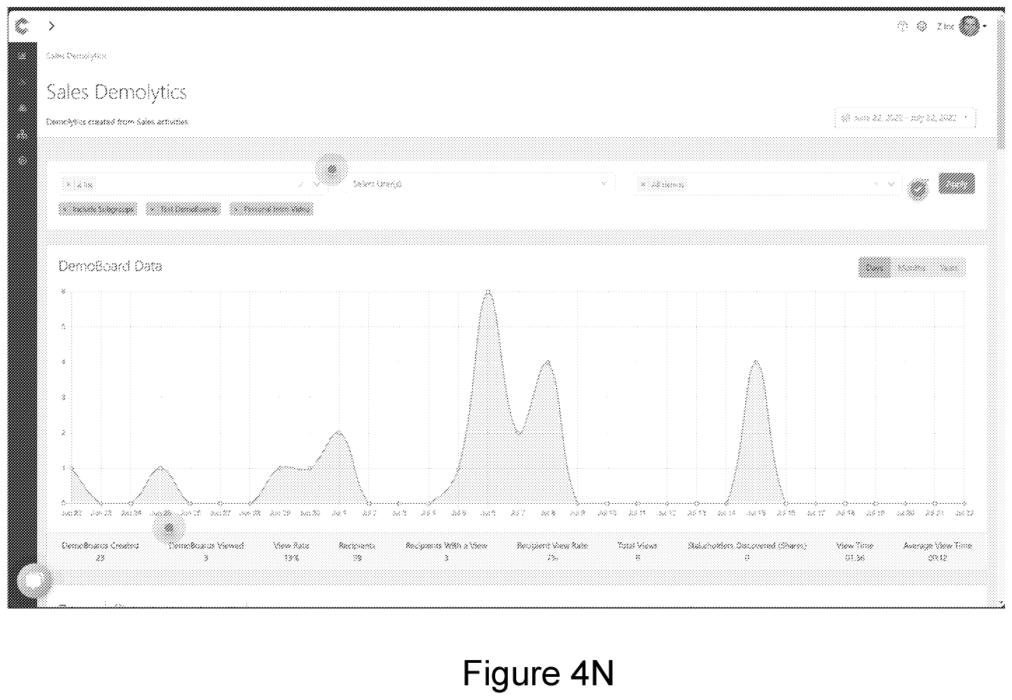

Upon receiving access to or accessing the created customizable demo by a client device 106 of the recipient/end user, at 314, the demo application 108 or instance thereof may identify the user and, based on the identification, serve the demo including demo information to the client/user device. For instance, the user may enter or select their identity or user role. The demo application 108 may determine an associated introduction (whether text, video, etc.), which may have been defined at 302 or 312 and which the demo application 108 displays to the user. FIG. 4A illustrates an example graphical user interface including a home screen for a demo in which a user is identified. The home page may be customized by the demo application 108 for a demo and/or for a company, user, etc., sending or receiving the demo. As illustrated, the demo application 108 may provide and gather information using a conversational interface. For example, the demo application 108 may provide an introductory video uploaded or generated for the identified user by an administrator.

As illustrated in the example of FIG. 4B, the demo application 108 may provide a graphical user interface displaying an introduction to the demo or the demo customizability, which may be provided in various formats, such as a video. For example, the demo application 108 may provide a personal introduction video for the demo and/or user. For example, when an account executive or sales professional sends a demo to a user, the demo application 108 may allow the administrative user to upload or record a personal video for a specific user, which may be displayed when the user is identified.

At 316, the demo application 108 may provide a graphical interface to the user on a client device 106 displaying topics and interaction elements allowing selection of a level of interest for each topic. For instance, as illustrated in the various example graphical user interfaces herein, a user may select an interest level (e.g., “very important,” “somewhat important,” “not important”) for each topic. For example, as illustrated in the example of FIG. 4C, the demo application 108 may display a graphical user interface in which topics are provided in a grid with levels of importance/interest, which may be selected by the user. The demo application 108 may automatically generate a list of topics based on the topic cards or topics defined by the administrator. The demo application 108 may display the topics in a list view 406, as illustrated in the example, with associated columns 408 indicating levels of interest for selection by the user, which may be shown in interactable graphical elements or buttons, a drop-down list, a text entry field, a slider, or otherwise.

At 318, the demo application 108 may receive user input via the client device 106 and the interaction elements selecting the level of interest for each topic. The interaction elements may be graphically updated to reflect their selection and each element may be adjusted at the start of a demo or later, such as during the demo. The demo application 108 may also customize other elements of the graphical interface for the user based on the selection and other criteria, as described below.

FIGS. 4D-4F illustrate example graphical interfaces displayed by the demo application 108, which illustrate selected levels of interest for each topic. A first set of interest levels is selected in FIG. 4D, and a second set of interest levels is selected in FIG. 4E.

For example, as selected by the user, each interest level for each topic may be highlighted or otherwise modified to indicate its selection and/or interest level. As shown in the example graphical user interface of FIG. 4D, as interest levels are selected by a user, the demo application 108 may automatically select and generate a demo summary of topics (e.g., in a side bar 410), which may be ordered based on interest level, of the topics in a customized demo. In some implementations, the topics and/or topic cards may be ordered first based on selected interest level and second, within each interest level, based on an administrator-defined order.

For instance, graphical topic cards 412 may represent each topic and may be graphically organized in an order and/or under a heading (or in a section, etc.). Each graphical topic card may display a summary or outline of information included for the topic, such as a video, tour, etc. In some implementations, the topic cards may display and/or include different information based on the selected interest level for each topic. For instance, a longer video and/or tour may be shown for higher-importance topics, fewer tour elements may be shown for lower-importance topics, or otherwise.

FIG. 4F illustrates another example graphical interface in which a content region or player provides a demo narrative that may be customized, for example, similar to 4D and 4E, by displaying selection of graphical elements representing interest levels an end user allowing them to provide input on the content and detail in the demo while also maintaining a narrative flow as originally created.

At 320, the demo application 108 may determine a flow order/sequence of topic cards based on the topics, selected levels of interest, and administrative defined ordering criteria/narrative flow. For example, the demo application 108 may take the topics selected as “very important” and order them according to an administrator defined order, and it may then take the topics selected as “somewhat important” and order them according to an administrator defined order, such that all “very important” topics are ordered to be prior to the less-important topics. Accordingly, in this example, the flow order of topics/topic cards may be determined based on both the end-user's selections/inputs and on the criteria defined by the administrator. Additionally, as noted below, topic data (e.g., text, video, tours, etc., of a topic/topic card) may be selected to be part of the demo and/or ordered based on the selected interest levels, as noted below.

As illustrated in FIGS. 4D-4G, a graphical region 410 on the graphical interfaces may display graphical topic cards in various orders based on the various selected levels of importance. Similarly, as illustrated, each card may be displayed differently based on the corresponding interest level of the corresponding topic. Similarly, the quantity of topics, tours, tour elements, estimated completion time or other data may also be displayed.

In some implementations, at 322, the demo application 108 may customize each topic card based on a level of interest for each topic. For instance, the demo application 108 may organize topic data for each topic into a topic card, which may include a graphical element displayed on the graphical interface. Beneficially, the topic cards may be displayed according to the dynamically determined order on the graphical interface, for example, in a vertically or horizontally rendered sequence or timeline. The topic cards may indicate data in each card (e.g., video, tours, text, etc.) based on the selected level of interest for that topic and, accordingly, may be dynamically defined/determined/generated and displayed based on the interactions/inputs by the end user.

As noted elsewhere herein, in some implementations, each tour, for example, for a topic, may include a story path, which may include a sequence and/or set of tour elements and/or pages/images that explain the topic, for example, in a narrative flow. As the topic cards are organized, for example, based on the selected preference levels, the demo application may automatically determine an overall order/sequence and/or automatically link each story path together.

At 324, the demo application 108 may generate a customized demo including the topic data according to the determined flow order and using the customized topic cards. For instance, the data (e.g., media, videos, tours, etc.) for a topic may be selected and/or ordered in a customized topic card based on selected interest levels and their association with the data for the topic. The topic cards may then be ordered based on the interest ranking and/or user (administrator and/or end-user) inputs, as noted above.

At 326, the demo application 108 may estimate a completion time of the customized demo using the customized topic cards and flow order. For instance, based on the specific topic cards and/or topic data (e.g., tours, videos, etc.) therein, the demo applications 108 may sum estimated completion times to determine an overall demo completion time.

At 328, the demo application 108 may display a preview of the customized demo including the customized topic cards according to the dynamically determined order and, in some instances, the projected completion time. For example, as described elsewhere herein, an example graphical user interface may include a timeline region showing the topic cards, elapsed time, remaining time, and/or overall completion time. The cards may display graphical indicators of the dynamically selected data included in each card, as noted above.

In some implementations, at 330, the demo application 108 (e.g., responsive to user input) initiates the customized demo including presenting topic data, such as media or other information, for a customized topic card in the order flow. The first data element, such as a video, for a first topic card in the flow, may be displayed to begin the demonstration. For instance, as described elsewhere herein, each topic or topic card may have a tour and/or one or more media segments, which may be organized into a narrative flow or one or more story paths.

For example, FIG. 4G illustrates an example graphical user interface in which a topic card 412 in a graphical region 410 is selected and/or graphically updated to indicate its selection. For example, the segment of the demo, relating to the topic, and graphically represented by the topic card may show that the topic is being viewed. The topic card may include a graphical element that may be selected to show a video, such as an introductory video, that is played for the topic in a content region 414, and a corresponding card and card element are updated to illustrate that it/they are active.

At 332, the demo application 108 may (e.g., responsive to completion of the first element/video or another step in a story path for the topic) present a tour for the active topic card. For example, where the first topic card includes a second component, which is a tour, the tour may be automatically or manually started. Although only a video and tour are described in reference to a card/topic, a card may include any number or type of elements. Displaying a tour may include displaying one or more hot spots or other graphical elements overlayed on the graphical interface of the tour. Similarly, hot spots may be displayed over any portion of the interfaces of the demo.

FIG. 4H illustrates an example graphical interface for skipping/delaying or initiating and performing a tour selected as part of a topic card.

The tour may include an interactive, step-by-step tour of a feature, topic, or subtopic, etc., such as of a service, website, software, product, or other subject. In some implementations, the tour may include a set or sequence of one or more images over which tour elements may be overlayed. For example, a tour element may include a graphical element that is static or with which an end user may interact (e.g., an HTML button or other element). For instance, a tour element may include a text bubble, hot spot, highlighted region, video audio segment, link to a webpage, or an interactable element. For example, a tour element may include a graphical element that provides interactions and that a user may interact with and that, in response, displays defined information. For example, a user may click or hover over a button based on which the demo application 108 may change the appearance of the button, display other information, allow text to be entered, display a drop-down menu or list, or perform other actions. For example, an HTML element may be associated with a defined location on a background image, so that a tour page, while being a static image, simulates use of software or a webpage being toured.

When the customizable demo is being defined by an administrator, as discussed above, a tour element may be associated with a defined location on a page or image. For example, the defined elements (e.g., hot spots) may be displayed at the locations defined by the administrative user. The hot spots may remain connected to defined graphical elements even as the interface is resized to match various aspect ratios and display sizes or resolutions.

As noted, the demo application 108 may display the hot spots or other tour elements, which may be hovered over and/or selected to provide additional information within the tour or other element of a card. For example, the user may select a hot spot, which may be a graphical button, in a tour of a topic/subtopic. The demo application 108 may display an overlay including additional information relating to the hot spot. In some implementations, the overlay may include an additional video pertaining to the topic and/or aspect of the topic relating to the hot spot. In some implementations, the overlay may include multiple layers of data, which may be selected/entered, such as a video within (e.g., in an overlay associated with a hot spot) a video, a tour within a tour, or a video within a tour, etc. Accordingly, the demo application 108 may organize information in a hierarchical way that further provides information based on interest level or needs and that further limits or expounds on information in a way that improves bandwidth and processor usage.

For example, at 334, the demo application 108 may display one or more additional layers of data based on the interaction with the hot spots, cards, card elements, tour elements, videos, or otherwise. In some implementations, a topic card may be expanded to show elements, which may also be expanded to show steps or data in the tour/demonstration, such as additional media, information displayed in association or based on selection of hot spots in a tour, etc.

For example, as discussed elsewhere herein, when a tour element is selected, it may display an overlayed box, such as a text bubble with video, text, titles, interactable elements, or other data. A user may select elements that are linked to or otherwise display additional tours, videos, topics, or information. Accordingly, a user viewing the tour or tour element may receive additional information about a topic/subtopic for which they have interest, for instance, without the demo application 108 departing from a story path of a tour or topic card. In some implementations, a tour element may provide graphical buttons or links that allow a user to select a next step or series of steps in a story path, so that the story path branches off to display different series of tour elements, tours, or otherwise.

In some implementations, at 336, the demo application 108 may update the graphical display of the tour element(s) and/or topic cards based on user interactions. For instance, once a hot spot has been selected, the demo application 108 may change the way it is displayed (e.g., change a circle to a checkmark). Similarly, cards or elements within cards may be updated to indicate that they have been started, skipped, or completed. For example, as illustrated in the figures, as each video or tour is completed, a play symbol may be changed to a checkmark to illustrate that it has been completed. In some instances, as elements or cards are completed, the demo application 108 may update the timeline and/or the estimate of the completion time.

FIGS. 4I and 4J illustrate example graphical user interfaces that may be displayed by the demo application 108 and that show tour elements, which may be displayed in various locations on a demo and/or in a tour. For instance, the example tour illustrated in FIGS. 4I and 4J provides a tour of a demo application 108. For instance, the example graphical user interface in FIG. 4I shows hot spots 422a, 422b, 422c, and 422d that may be displayed as circles and, once viewed, changed to checkmarks, as shown in the hot spot 422e in FIG. 4J. For example, the demo application 108 may track interaction(s) with tour elements and, in some instances, display representation(s) of the interaction(s).

Selection of the hot spots may overlay graphical elements, tours, or videos over the interface based on the hot spot(s). The overlays may be expanded to be full screen and/or provide additional layers of data. For example, an overlay may include demos, videos, etc. For instance, when the hot spot 422a in FIG. 4I is selected (e.g., whether by a click, hover over, or automatically based on the hot spot 422a being a next step in a story path), a text box 424a may be displayed describing something displayed on a page or in an image underneath or adjacent to the hotspot 422a. Similarly, as shown in the example of FIG. 4J, a hot spot 422f is selected, which may cause an overlay box 424b that includes an additional video, a title, a description, or other layers of media in the box 424b and pertaining to the hot spot 422f.

FIG. 4K illustrates an example graphical user interface of the demo displayed by the demo application 108, which may include graphical elements representing documents curated for the demo and/or the topic being viewed. For example, the demo application 108 may automatically display graphical elements 426 representing supplemental documents specific to those topic(s) deemed “very important” or “somewhat important” while excluding those documents for topics deemed “not important.” As with the other topic data, documents may be associated with varying levels of detail. The demo application 108 may also provide a graphical element via which all determined supplemental documents may be downloaded for the customized tour.

At 338, the demo application 108 may determine whether there are additional cards or topics in the customized demo. If there is an additional card, the demo application 108 may move to the next card in the determined order flow, as described above, and proceed to present it to the user. At any point, the demo application 108 may facilitate the user contacting an/the administrator, sharing the demo or portion thereof with another user, requesting help, revisiting previous cards/elements, skipping to later cards/elements, or performing other actions.

If there are no other cards in the tour, the demo application 108 may provide conclusion information or receive other inputs. For instance, at 340, the demo application 108 may receive other user interactions, such as revisiting topic cards or sharing the dynamically customizable tour with other users. The demo application 108 may provide an opportunity to the user to dive into a topic in more detail, for example, by viewing a card and/or card element at a higher level of interest than previously selected. Similarly, if the demo application 108 did not present a card for a certain topic (e.g., where a “not interested” level was selected), it may provide an opportunity to the user to view a card and/or card element for that topic. For instance, as illustrated in the example graphical user interface of FIG. 4L, the demo application 108 may display a window 428 overlayed over or displayed after the demo allows a user to add other topics to the generated, customized demo, or otherwise view additional information for the demo.

The demo application 108 may allow the user to share the customized and/or customizable demo with one or more other users. The demo application 108 may track the other users with whom the demo is shared and automatically update the set of users associated with an administrator or organization based on the set of users that have received sharing access. For example, FIG. 4M illustrates an example graphical user interface showing a window 430 overlayed over or displayed separately or after the demo that allows the user to share the demo with other users. The user may provide name, contact information, user role, a message, or other data.

In some implementations, the demo application 108 may, as a user accesses or interacts with various components of a demo, aggregate data and perform analytics on the access/interactions. For example, at 342, the demo application 108 may gather, perform, and present analysis for user interactions with the customizable demo. The demo application 108 may track a user's indicated interests, the amount of time spent on each topic, the quantity of times the demo or topic was viewed, which tour elements a user has interacted with or viewed, progress through one or more story paths, or other information and provide the data/analytics to an administrator. In some instances, the access/interactions may be tracked across users and/or demos thereby allowing analytics based on user role, demo, topic, different topic data, etc., thereby facilitating optimization of the demos. For example, the demo application 108 may determine which demos, topics, or elements (e.g., tours, videos, etc.) are typically deemed “most important,” receive the highest levels of user interaction, or are most effective, etc.

FIG. 4N illustrates an example graphical user interface in which the demo application 108 displays example analytics for a demo, which may be sorted based on company, demo, users, user roles, time period, topics, or other data. In some implementations, overlays associated with hot spots may automatically be generated that include additional information aspects of the analytics or the interface.

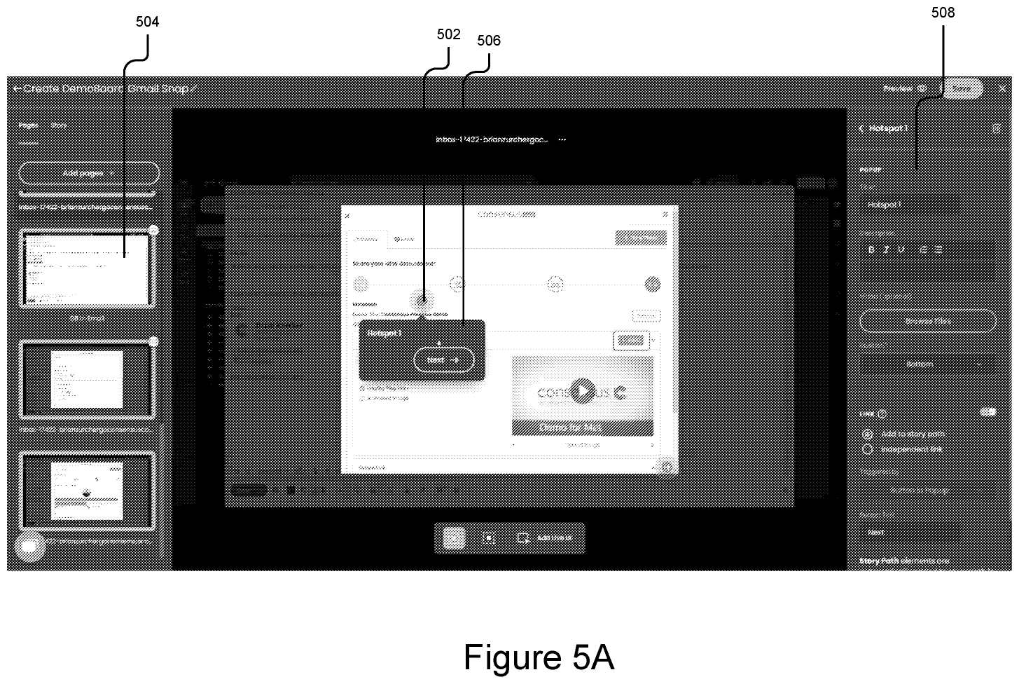

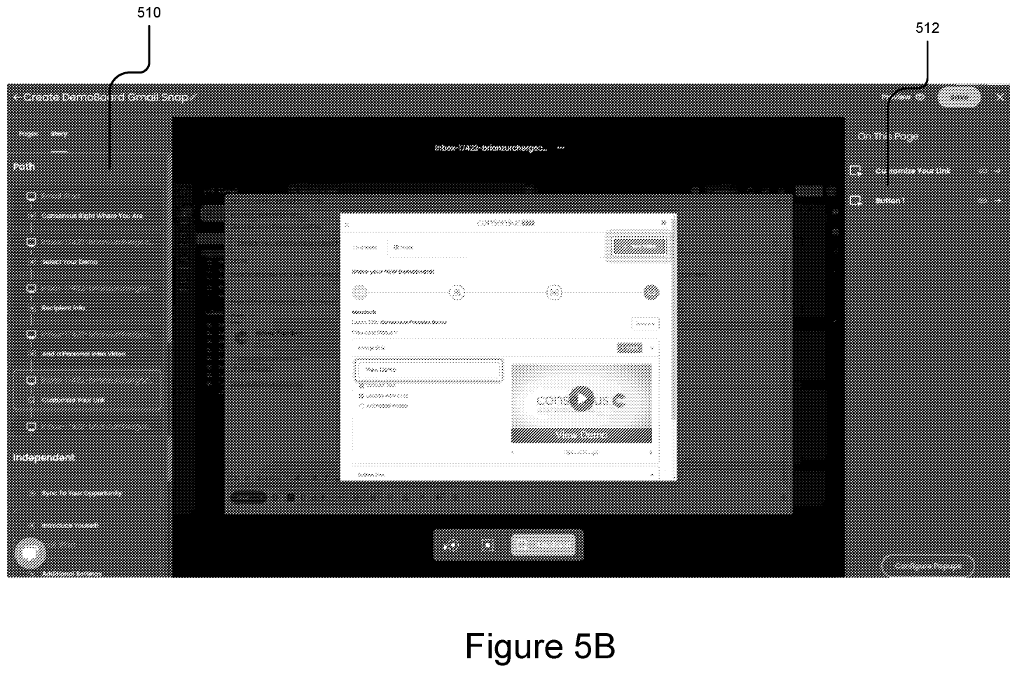

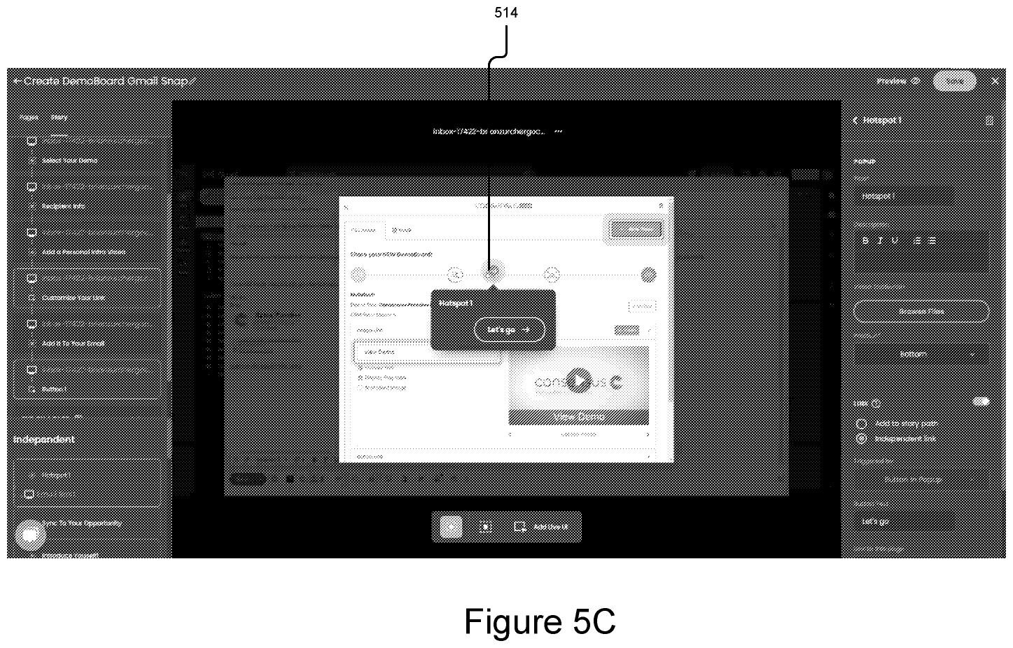

FIG. 5A illustrates an example graphical user interface in which a tour element may be used to define user interface elements overlayed over an image. A set of pages and/or tour elements may be used as or in a tour, for example, which may be or be in a topic card of a demo, as noted above. The sequence of pages and/or tour elements may have a defined sequence or story path. In the illustrated example, a hotspot 502 may be defined, which may be a circular graphical element that draws attention to a portion of the image (e.g., for a story path step). A circular hotspot, rectangular boundary hot spot, highlighting, or a live user interface tour element may be selected and defined in both its appearance and behavior when selected or hovered over. For example, a hotspot may be associated with and overlayed over a defined location on the image. When selected or hovered over, the hotspot 502 may display textual information or media and an element (“next”) that may be selected to move to a next step in a story path. In some implementations, multiple action elements may be displayed in a popup 506 associated with a hotspot 502, so that the user may select from and proceed through one or multiple story paths or otherwise view more depth, information, or media for a subject or subtopic corresponding to the hotspot 502.

Additionally, FIG. 5A illustrates a panel via which pages/images may be added to a demo. The pages may be rearranged to change their order (along with the relative orders of user interface elements on each page) in a graphical panel 504, which may show the pages added to the demo.

The example graphical user interface in FIG. 5A also illustrates a tour element definition panel 508, which once a tour element of a defined type (e.g., a hotspot, button, highlighted region, HTML live element, etc.) is placed on a page (e.g., in association with a defined location on an image), the demo application 108 may display options for defining the tour element. For example, the definition may describe attributes of the tour element, information or media displayed based on interaction with the tour element, or demo application 108 behavior based on interaction with the tour element. For example, the tour element definition panel 508 may allow a title, description, video file, position, format, link type, display trigger, button text, or various other attributes to be defined.

As described elsewhere herein, as a tour element is added to a tour, it may automatically be placed in a sequence or story path of multiple tour elements and/or pages, which may be displayed to the user. For example, as a user interacts with a tour element or clicks “next” whether on the page or on a popup of a tour element, the demo application 108 may proceed to display and/or unlock a subsequent tour element. The administrator may change the order or display logic for the tour elements, for example, by manually dragging representations of tour elements in a graphical side panel (e.g., 510, as discussed below).

Depending on the implementation, the demo application 108 may require that a user view, interact with, or complete interaction (e.g., by performing defined actions or providing defined inputs) with one or more tour elements in order to proceed to another tour element.

In some implementations, multiple story paths or logic for selecting a story path or subsequently displayed tour element may also be defined by the administrator.

In some implementations, in the tour element definition panel 508, the administrator may define that the tour element is linked to one or more story paths/sequences of steps or that the tour element is independent from the story path(s). Accordingly, the demo application 108 may display and/or lead an end user through a story path, but the end user may exit or ignore the story path and interact with an independent tour element (e.g., a hotspot). Accordingly, a tour displayed by the demo application 108 may include both independently interactable elements and elements that are part of a sequence of displayed or must-be-completed items in a story path.

FIG. 5B illustrates an example graphical user interface in which a story path is graphically represented on a graphical side panel 510 (e.g., the graphical side panel 504 may be changed to display the story path). For instance, the images, user interface elements, and other data may be displayed for an image or the entire demo. Independent user interface elements may also be displayed. In some cases, a second graphical panel 512 may be displayed showing solely those user interface tour elements on the displayed image or page, which may be used to reorder or redefine the user interface elements. For example, where the tour user interface elements are or include popups, the popups may be defined.

FIG. 5C illustrates an example graphical user interface in which a hotspot 514 is defined within the context of a story path. For instance, an attribute of the hotspot indicating whether the hotspot is in the story path or is independent from the path may be manually defined by an administrator (e.g., a user having a role or account of creating a demo) in the second graphical panel 512 discussed above. As noted above, where UI elements are added to the story path, they may be automatically added in the order in which they are created, but they may be reordered.

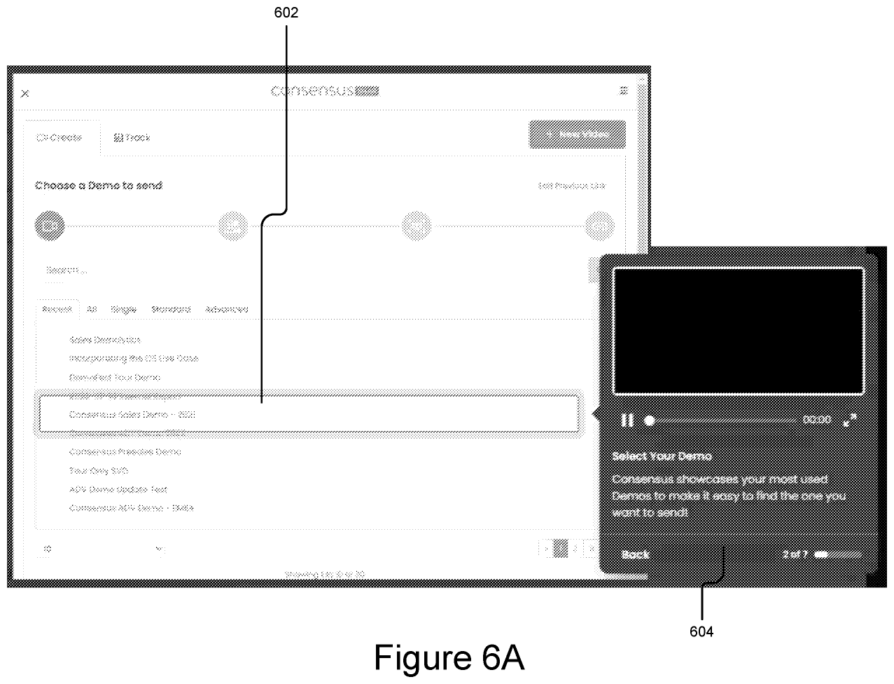

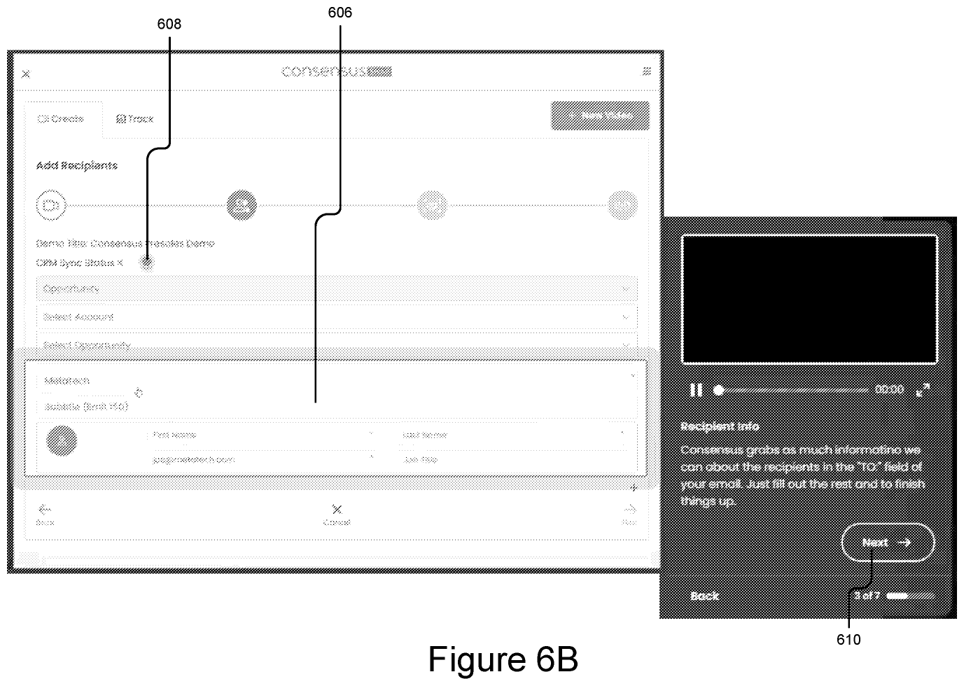

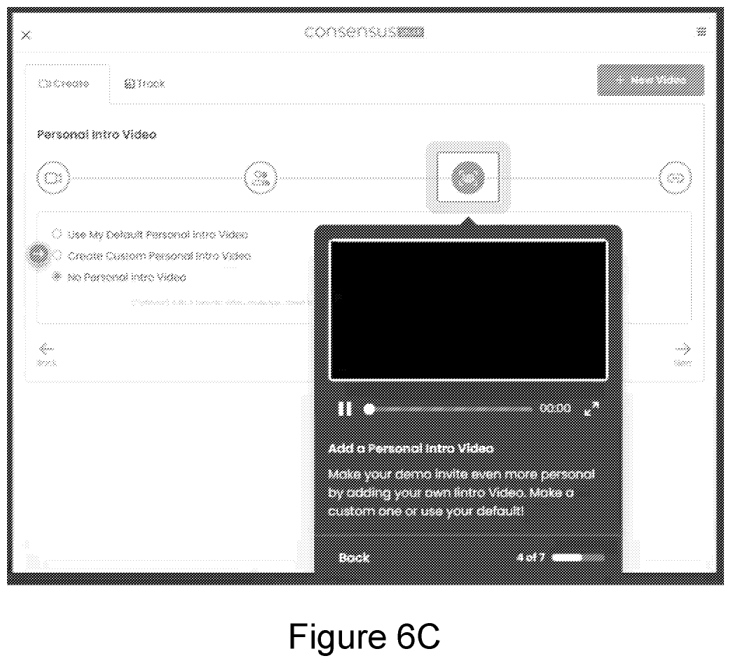

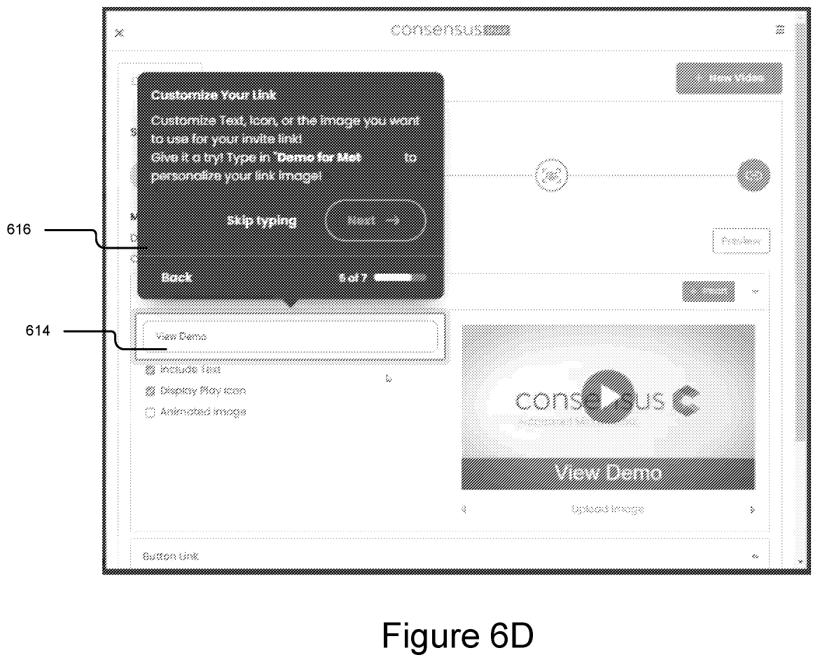

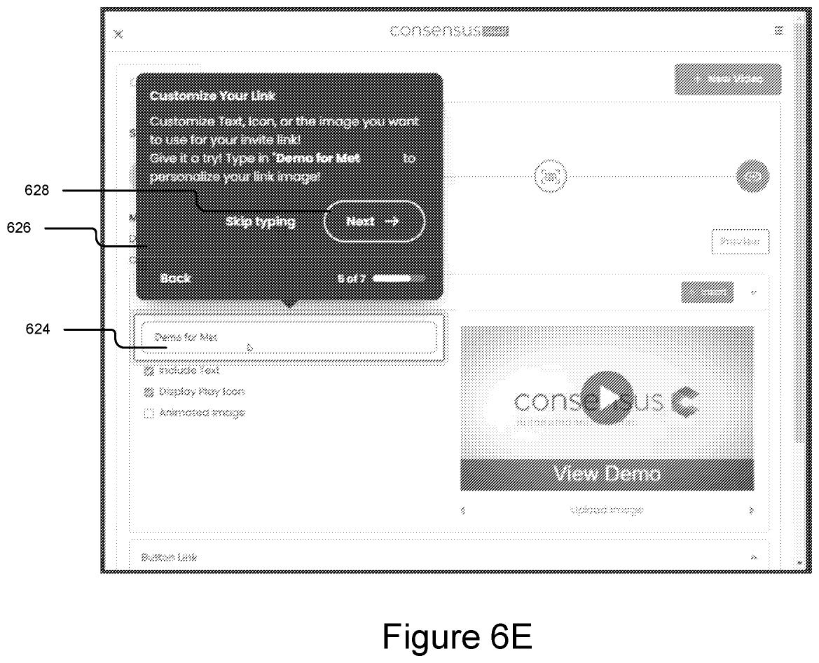

FIG. 6A illustrates an example graphical user interface in which a demo is displayed to a user. In the example, a rectangular hotspot/UI/tour element 602 is shown highlighting an area on the image. When the image or tour element is selected (e.g., clicked, hovered over, or automatically selected based on a sequence of steps in the story path), a popup 604 showing a title, description and other information may be displayed on the interface. For example, the popup may include a video, a navigation element showing or allowing navigation backward or forward in the story path may be shown. Similarly, in some instances, the popup may show a current position in percentage or step number of in the story path. In some implementations, a conversational interface guides a user through the customization and/or use of a demo or tour, which may improve user engagement.

For instance, the demo application 108 may provide one or more graphical user interfaces for providing personalized product tours or demos. For example, tours may provide users clickable experiences with a product. As described above, like a video, the demos may be displayed or withheld based on user interest. As illustrated and as discussed above, the user may interact with a digital product or otherwise tour a product by interacting with the tour in the graphical interface. Instructional pop-ups or overlays (e.g., based on selection of hot spots) may, beneficially, include video content. For example, as illustrated, the overlay may include an embedded or framed video player and/or text providing additional information relating to the hot spot. Where videos are used as part of a tour or topic card in a demo, customizing, by the demo application 108, the display, processing, transmission, or other operations respective to the demo and/or tours within a demo may further amplify the technical benefits of the technology described herein, for example, by reducing resource utilization.

FIG. 6B illustrates an example graphical user interface in which a next step 606 (e.g., step in a story path associated with a tour element) is shown in the demo, which next step is similar to that illustrated in FIG. 6A (although defined differently and overlayed on a different image). An additional hotspot 608 that is independent of the story path is also shown and may be selected by a user. In some implementations, the demo application 108 may detect when a user has completed interaction with a tour element and unlock or display a “next” button/element 610, which allows the tour to proceed to a next step in a story path.

FIG. 6C illustrates an example graphical user interface in which a next step is shown in the story path. The next step may be displayable (e.g., by selecting the “next” element 610) or automatically displayed based on completion of a previous step. In some implementations, an information window or popup associated with a hotspot, button, or other tour element may be displayed based on interaction with that tour element. In some implementations, the window or popup may be automatically displayed when the tour moves to the step in the story path.

FIG. 6D illustrates an example graphical user interface in which a next step in a story path is displayed. For example, the next step in the path may be on a different page/image than the previous page/image and may be automatically displayed based on completion of a previous step and/or based on interaction with a UI element. In the depicted example, the live user interface tour element may be a text-input field 614 (e.g., illustrated by a highlighted boundary box) and may include a popup 616 displayed based on interaction with the tour element or displayed automatically. The popup 616 may provide instructions or other information for the tour element or underlying feature represented in the image. For instance, the typing element may allow a user to skip the action required by logic associated with/defined for the tour element, move to the next step, or provide instructions or questions for completing the action required by the tour element.

In the depicted example, the text-input field live tour element/field 614 is overlayed over a portion of the image (e.g., where a text-input field would have been located in the original application being toured). The text-input field 614 may display text and/or receive text. For example, the popup 616 instructs the user to enter defined text (e.g., “Demo for Met”) into the field. In response to receiving the defined text, the demo application 108 may update the field (e.g., to include the typed text), mark the step as complete, and allow movement to a next step in the story path. For example, in FIG. 6E, the text-input field 624 includes the entered text and a “next” button 628 in the popup 626 is updated to allow navigation forward.

In some implementations, an administrative user may view and/or actively control a demo as it is viewed and/or interacted with by an end user, for example, to allow the administrator to walk the end user through the demo. In some implementations, one or more of the tour elements and/or media segments (e.g., separate to or included in a tour element) may be replaced, for instance, by a live video or audio stream of the administrator communicating with the end user.

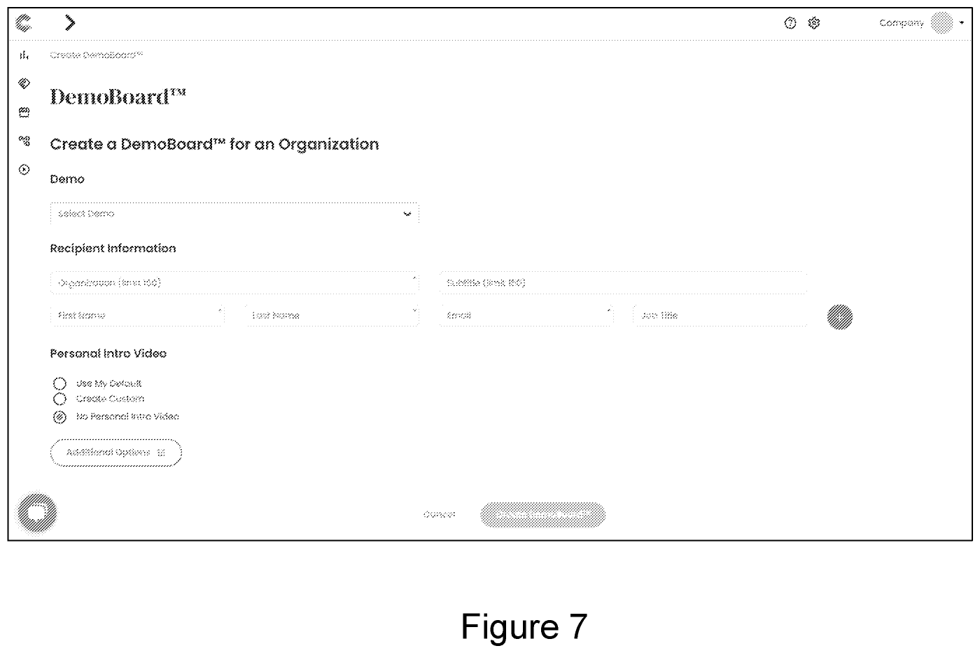

FIG. 7 illustrates an example graphical user interface displayed by a demo application 108, which an administrator may use to create a demo for an organization, end user, product, etc. For instance, the graphical interface may allow an administrator to title the demo, customize it to a specific user to which it may be sent, add personalized media, such as a video, or perform other operations. Various elements may be automatically filled by the demo application 108, such as where a previously created or default demo may be selected and associated fields are filled. Similarly, the demo application 108 may predictively fill one or more fields as a user types into the fields, for example, based on database of demos, clients, users, or otherwise.

It should be noted that other operations, orders, and features are contemplated herein. For instance, the technology may use fewer, additional, or different operations or orders of operations than those described herein without departing from the scope of this disclosure. It should be noted that although the operations of the method 300 are described in reference to the demo application 108, they may be performed by different components of the system 100, distributed, or otherwise modified without departing from the scope of this disclosure.

It should be noted that other operations, orders, and features are contemplated herein. For instance, the technology may use fewer, additional, or different operations or orders of operations than those described herein without departing from the scope of this disclosure. It should be noted that although the operations of the method 300 are described in reference to the demo application 108, they may be performed by different components of the system 100, distributed, or otherwise modified without departing from the scope of this disclosure.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions and/or formats. Furthermore, the modules, routines, features, attributes, methodologies, and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method of generating a digital demonstration for a subject matter comprising:
receiving, by one or more processors, one or more first inputs selecting an interest level from among a plurality of interest levels for each of a set of topics;
determining, by the one or more processors, displayable information describing a subset of the set of topics based on the one or more first inputs, the displayable information including one or more media segments;
generating, by the one or more processors, a sequence for the displayable information for the subset of topics using the one or more first inputs and defined ordering criteria; and
presenting, by the one or more processors, for display in a graphical user interface on a client device, a digital demonstration including the sequence of the displayable information for the subset of topics.

2. The computer-implemented method of claim 1, wherein presenting the digital demonstration includes:
presenting, by the one or more processors, a digital tour for a topic of the subset of topics, the digital tour providing information relating to the topic in the digital demonstration, the digital tour including a sequence of steps that describe subtopics of the topic.

3. The computer-implemented method of claim 2, wherein presenting the digital tour for the topic includes:
overlaying, by the one or more processors, at a defined location on an image for the topic, an interactable graphical element;
receiving, by the one or more processors, by the client device, a second user input selecting the interactable graphical element;
in response to receiving the second user input, displaying, by the one or more processors, a video segment in a media player in an overlay at a location associated with the selected interactable graphical element; and
updating, by the one or more processors, the selected interactable graphical element to indicate that user has interacted with the selected interactable graphical element via the graphical user interface.

4. The computer-implemented method of claim 2, wherein:
the digital tour includes an interactable graphical element for each step in the sequence of the steps, the interactable graphical elements for the sequence of steps being displayable subject to the sequence of steps; and
the digital tour includes one or more independent graphical elements displayable in the digital tour independently from the sequence of steps.

5. The computer-implemented method of claim 1, further comprising:
receiving, by the one or more processors, data including a plurality of images for the digital demonstration;
determining, by the one or more processors, a sequence of the plurality of images; and
associating the plurality of images with a topic of the set of topics.

6. The computer-implemented method of claim 5, further comprising:
receiving, by the one or more processors, multiple media items for the digital demonstration;
associating, by the one or more processors, each of the multiple media items with one or more of the set of topics; and
associating, by the one or more processors, each of the set of topics with one or more of the plurality of interest levels.

7. The computer-implemented method of claim 6, further comprising:
determining, by the one or more processors, the defined ordering criteria including determining a sequence of the set of topics based on one or more second inputs, the sequence for the displayable information for the subset of topics being based on the sequence of the set of topics and the one or more first inputs selecting the interest level for each of the set of topics.

8. The computer-implemented method of claim 1, wherein:
the defined ordering criteria includes a first sequence of the set of topics and a second sequence of information elements within each topic of the set of topics.

9. The computer-implemented method of claim 8, wherein:
a digital tour is associated with a topic of the subset of topics, the digital tour including the second sequence of the information elements in a story path defining logic for displaying the information elements in the digital tour for the topic.

10. The computer-implemented method of claim 1, further comprising:
displaying, by the one or more processors, in the graphical user interface on the client device, a set of topic cards for subset of topics based on the one or more first inputs and the defined ordering criteria.

11. The computer-implemented method of claim 10, wherein:
each topic card of the set of topic cards includes a summary of information elements associated with the topic card, each topic card being associated with a topic of the subset of topics.

12. The computer-implemented method of claim 11, wherein:
a topic card of the set of topic cards includes a graphical element representing a video associated with the topic, the graphical element representing the video being selectable to open a popup window in the graphical user interface, the popup window displaying the video.

13. The computer-implemented method of claim 11, further comprising:
a topic card of the set of topic cards includes a graphical element representing a digital tour associated with the topic, the graphical element representing the digital tour being selectable to display the digital tour in a content region of the graphical user interface, the digital tour including a set of images with a plurality of hotspot graphical elements overlayed on one or more of the set of images in the content region.

14. A system comprising:
one or more processors; and
a computer-readable memory storing instructions that, when executed by the one or more processors, cause the system to perform operations including:
receiving one or more first inputs selecting an interest level from among a plurality of interest levels for each of a set of topics;
determining displayable information describing a subset of the set of topics based on the one or more first inputs, the displayable information including one or more media segments;
generating a sequence for the displayable information for the subset of topics using the one or more first inputs and defined ordering criteria; and
presenting for display in a graphical user interface on a client device, a digital demonstration including the sequence of the displayable information for the subset of topics.

15. The system of claim 14, wherein presenting the digital demonstration includes:
presenting a digital tour for a topic of the subset of topics, the digital tour providing information relating to the topic in the digital demonstration, the digital tour including a sequence of steps that describe subtopics of the topic.

16. The system of claim 15, wherein presenting the digital tour for the topic includes:
overlaying at a defined location on an image for the topic, an interactable graphical element;
receiving by the client device, a second user input selecting the interactable graphical element;
in response to receiving the second user input, displaying a video segment in a media player in an overlay at a location associated with the selected interactable graphical element; and
updating the selected interactable graphical element to indicate that user has interacted with the selected interactable graphical element via the graphical user interface.

17. The system of claim 15, wherein:
the digital tour includes an interactable graphical element for each step in the sequence of the steps, the interactable graphical elements for the sequence of steps being displayable subject to the sequence of steps; and
the digital tour includes one or more independent graphical elements displayable in the digital tour independently from the sequence of steps.

18. The system of claim 14, further comprising:
receiving data including a plurality of images for the digital demonstration;
determining a sequence of the plurality of images; and
associating the plurality of images with a topic of the set of topics.

19. The system of claim 18, further comprising:
receiving multiple media items for the digital demonstration;
associating each of the multiple media items with one or more of the set of topics; and
associating each of the set of topics with one or more of the plurality of interest levels.

20. A computer-implemented method comprising:
receiving, by one or more processors, one or more first inputs selecting an interest level from among a plurality of interest levels for each of a set of topics;
determining, by the one or more processors, displayable information describing a subset of the set of topics based on the one or more first inputs, the displayable information including one or more media segments;
generating, by the one or more processors, a sequence for the displayable information for the subset of topics using the one or more first inputs and defined ordering criteria; and
presenting, by the one or more processors, for display in a graphical user interface on a client device, a digital demonstration including the sequence of the displayable information for the subset of topics including:
presenting a digital tour for each topic of the subset of topics, the digital tour providing information relating to the topic in the digital demonstration, the digital tour including a sequence of steps that describe subtopics of the topic, the digital tour including a plurality of images and a plurality of tour elements overlayed at defined locations on the plurality of images, the defined ordering criteria including a first sequence of the set of topics and a second sequence of the steps within the topic.
